(19) United States
(12) Patent Application Publication
(10) Pub. No.: US 2024/0215622 A1
(43) Pub. Date: Jul. 4, 2024

(54) SWEETENER FORMULATIONS

(71) Applicant: DOUXMATOK LTD., Petach Tikva (IL)

(72) Inventors: David TSIVION, Kfar Shmaryahu (IL); Ronit ROMM, Jerusalem (IL); Alejandro MARABI, Tel Aviv (IL); Liron BITAN, Petach Tikva (IL); Naama LAHAV, Hod Hasharon (IL); Alexander TRACHTENBERG, Ramat Gan (IL); Bar PINCHAS, Hod-HaSharon (IL); Orel SHKALO, Kfar Saba (IL); Danielle LUBOTZKY, Givat Shmuel (IL); Moran FATTAL, Tel Aviv (IL)

(21) Appl. No.: 18/289,003

(22) PCT Filed: Jun. 1, 2022
(86) PCT No.: PCT/IB2022/055102

§ 371 Date: Oct. 31, 2023

Related U.S. Application Data
(60) Provisional application No. 63/195,287, filed on Jun. 1, 2021.

(51) Int. Cl. A23L 27/30; A21D 2/18; A21D 13/062; A23L 29/262

(52) U.S. Cl. CPC A23L 27/34; A21D 2/181; A21D 2/188; A21D 13/062; A23L 27/33; A23L 29/262

(57) ABSTRACT

Sweetener formulations including sweetener particles containing a sweetener selected from the group consisting of a sweetener carbohydrate and a sweetener polyol, and carboxymethyl cellulose (CMC) disposed within the sweetener particles.

This application draws priority from U.S. Provisional Patent Application No. 63/195,287, filed Jun. 1, 2021, which application is incorporated by reference for all purposes as if fully set forth herein.

### FIELD AND BACKGROUND OF THE INVENTION

The present invention relates to improved sweetener formulations and methods for making such improved sweetener formulations and utilizing them in food products, and more particularly, to sweetener formulations including carboxymethyl cellulose (CMC).

### SUMMARY OF THE INVENTION

According to teachings of the present invention there is provided a formulation comprising: (a) sweetener particles containing a sweetener selected from the group consisting of a sweetener carbohydrate and a sweetener polyol; and (b) CMC, disposed within the sweetener particles.

According to further teachings of the present invention, a weight-to-weight ratio of the CMC to the sweetener within the sweetener particles is within a range of 0.005% to 1.5%.

According to further teachings of the present invention, the average particle size, by weight, of the sweetener particles within the sweetener formulation is at least 50 μm.

According to further teachings of the present invention, the CMC is a mucoadhesive agent, such that a mucosal adhesion of the sweetener formulation is greater than that of a control formulation, the control formulation being devoid of the CMC, but being otherwise identical to the sweetener formulation.

According to further teachings of the present invention the mucosal adhesion of the sweetener formulation is greater than that of a control formulation by at least 1%, the control formulation being devoid of the CMC, but being otherwise identical to the sweetener formulation.

According to further teachings of the present invention the mucosal adhesion of the sweetener formulation is greater than that of the control formulation by at most 200%.

According to further teachings of the present invention there is provided an edible formulation comprising: (a) any of the formulations provided herein; (b) at least one fat; and (c) optionally, at least one starch; wherein a total concentration of the sweetener, the at least one fat, and the at least one starch, within the edible formulation, is at least 30%, on a weight basis.

### DESCRIPTION OF THE PREFERRED EMBODIMENTS

The present disclosure describes improved sweetener formulations and edible formulations, and methods for making such improved sweetener formulations and utilizing them in edible formulations such as food products. The sweetener formulations include one or more species of carboxymethyl cellulose (CMC) that may exhibit any of various mucoadhesive properties.

Examples of such carboxymethyl cellulose exhibiting mucoadhesive activity include, but are not limited to, sodium carboxymethyl cellulose, potassium carboxymethyl cellulose, calcium carboxymethyl cellulose, magnesium carboxymethyl cellulose, and hydrogen carboxymethyl cellulose.

The carboxymethylcellulose may be any of low, medium and high viscosity grades, and may be characterized both by a wide variety of average molecular weights and by a wide variety of degree of substitution/polymerization.

As used herein in the specification and in the claims section that follows, the terms “carboxymethyl cellulose” and “CMC” refer to at least one of (a) water-soluble species of CMC, and (b) a carboxymethylcellulose selected from the group consisting of sodium CMC, potassium CMC, magnesium CMC, calcium CMC, and hydrogen CMC.

As used herein in the specification and in the claims section that follows, the term “mucoadhesive agent” and the like refers to a substance exhibiting an affinity for attaching to a mucin layer of a mucosal surface of a human tongue, via mucoadhesion.

As used herein, the term “sweetener carbohydrate” refers to a nutritive or caloric sweetener having at least one carbohydrate moiety, which carbohydrate is processed by the human body to produce energy. A sweetener carbohydrate produces a sweet taste when consumed by the typical human consumer. If, on a normalized sweetness scale, on a weight basis, in which sucrose is taken as a standard of 1, maltose is about 0.31, and lactose is about 0.22, the term “sweetener carbohydrate” would apply to lactose, and to any sugar or other nutritive, carbohydrate-containing sweetener having a sweetness within a range of 0.15 to 2.5 on this normalized sweetness scale. Alternatively, it may be stated that the minimum sweetness for the sugar or other nutritive, carbohydrate-containing sweetener would be that of raffinose (which has a sweetness of 0.15 on the above-mentioned scale). More typically, such a sweetener carbohydrate has a sweetness within a range of 0.25 to 2.5, 0.35 to 2.5, 0.45 to 2.5, 0.25 to 1.8, 0.45 to 1.7, 0.15 to 1.7, or 0.35 to 1.5 on this normalized sweetness scale.

It is noted that the relative sweetness of fructose reported in the literature has been reported to be as little as 0.91, and as much as about 1.7. For the avoidance of doubt, the term “sweetener carbohydrate” is meant to include fructose, irrespective of any of its reported relative sweetness values.

As used herein, the term “normalized sweetness scale”, refers to a relative sweetness scale, on a weight basis, in which sucrose is assigned a value of 1.00. More specifically, the normalized sweetness scale is determined according to the methods disclosed in Moscowitz, H. “Ratio Scales of Sugar Sweetness”; Perception & Psychophysics, 1970, Vol. 7 (5), in which the power function for the sugars and polyols/sugar alcohols has an exponent of 1.3 (n=1.3), as disclosed therein in Table 3, and as provided hereinbelow.

From “Ratio Scales of Sugar Sweetness” (Table 3)

Percent by Weight Basis

| | Rank | Relative Sweetness |
|---|---|---|
| Sucrose | 1 | 1.00 |
| Fructose | 2 | 0.91 |
| Raftinose | 15 | 0.15 |
| Maltose | 12 | 0.31 |
| Lactose | 14 | 0.22 |
| Dulcitol | 5 | 0.46 |
| Glucose | 4 | 0.45 |
| Galactose | 6 | 0.42 |
| Sorbose | 7 | 0.41 |
| Sorbitol | 9 | 0.37 |
| Mannitol | 11 | 0.33 |
| Arabinose | 8 | 0.39 |
| Rhamnose | 10 | 0.35 |
| Glycerol | 3 | 0.50 |
| Xylose | 13 | 0.26 |

A sweetener carbohydrate may be a monosaccharide or a disaccharide. Examples of sweetener carbohydrates include, but are not limited to, sucrose, glucose, maltose, fructose, lactose, or any combination of sweetener carbohydrates. One or more sweetener carbohydrate may be combined with one or more sweetener polyols. A sweetener carbohydrate may be naturally occurring or synthetically produced.

As used herein, the term “sweetener polyol” refers to a consumable polyol that produces a sweet taste when consumed by the typical human consumer. Non-limiting examples of sweetener polyols include xylitol, maltitol, erythritol, sorbitol, threitol, arabitol, hydrogenated starch hydrolysates (HSH), isomalt, lactitol, mannitol, or galactitol (dulcitol). In many instances, the polyol is a sugar alcohol. A sugar alcohol can be produced from a carbohydrate by any known method of reduction (via a chemical or biological transformation) of an acid or aldehyde to an alcohol. In other cases, a sweetener polyol can be synthesized from a parent carbohydrate. Alternatively, a sweetener polyol may be obtained from a biological source.

For the avoidance of doubt, the term “sweetener polyol” is meant to include any polyol/sugar alcohol having a sweetness within a range of 0.15 to 2.5 on the above-described normalized sweetness scale. More typically, such a sweetener polyol has a sweetness within a range of 0.15 to 1.5, 0.15 to 1.0, 0.15 to 0.8, 0.15 to 0.7, 0.20 to 0.7, 0.15 to 0.6, or 0.25 to 0.6, on this normalized sweetness scale.

The term “carboxymethyl cellulose”, or “CMC”, as used herein, refers to a polymer structure of β-glucopyranose monomers whose hydroxyl units have been partially substituted with carboxymethyl units. The β-glucopyranose units are bound or linked by a glycosidic linkage. Such linkages may be effected using various enzymes.

CMC may be represented by the following molecular formula:

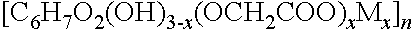

wherein n is the number of repeating units;
wherein M is an alkali metal (typically Na, K), hydrogen (H), or ½ alkaline earth metal (typically ½Ca, ½Mg);
and wherein the degree of substitution is represented by X.

The molecular structure, for a degree of substitution equal to 1 (X=1) may be represented as follows:

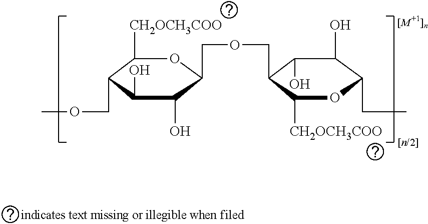

In some embodiments in which the sweetener formulation contains hydrogen CMC (H-CMC), the sweetener formulation exhibits a pH within a range of 4.5 to 11 at 25° C.

In some of these embodiments, the sweetener formulation exhibits a pH within a range of 5.0 to 11 at 25° C.

In some of these embodiments, the sweetener formulation exhibits a pH within a range of 5.5 to 10 at 25° C.

In some of these embodiments, the sweetener formulation exhibits a pH within a range of 6 to 9 at 25° C.

In some of these embodiments, the sweetener formulation exhibits a pH of at most 10.5 at 25° C.

In some of these embodiments, he sweetener formulation exhibits a pH of at most 9 at 25° C.

The degree of substitution (DS) of a CMC polymer is defined as the average number of carboxymethyl (OCH2COOM) groups per monomer unit. While it is apparent from the above-provided structure that the minimum theoretical DS is 0 (all 3 OR groups being OH), and the maximum theoretical DS is 3.0 (all 3 OR groups being OCH2COOM), in practice, DS lies within a range of 0.3 to 1.5, more typically 0.5 to 1.3, and yet more typically, 0.6 to 1.2 or 0.6 to 1.0.

The degree of polymerization (DP) of a CMC polymer is defined as the average number of the repeating units, n.

It will be appreciated by those of skill in the art that various characteristics of the CMC, such as molecular weight, viscosity and solubility, may be influenced or adjusted by modifications in the degree of substitution and the degree of polymerization. Typically, the viscosity is measured as a 1 wt. % dispersion in water at 25° C., for low-viscosity CMC polymers, and as a 2 wt. % dispersion in water at 25° C., for medium-viscosity and high-viscosity CMC polymers.

For example, for sodium CMC (at 25° C.) having a degree of substitution of 0.7, the degree of polymerization may be varied to achieve CMC products of different characteristic viscosities: a DP of 400 yields a “low viscosity CMC”; a DP of 1100 yields a “medium viscosity CMC”; and a DP of 3200 yields a “high viscosity CMC”.

The variety of states of disaggregation of the dispersions may also affect the viscosity of each dispersion. When the CMC is added to a sweetener syrup and approaches equilibrium in the disaggregation state, the CMC may swell to a point of maximum viscosity, remain as a suspended powder, reach maximum disaggregation or exist in an intermediate state.

Most of the polymeric hydrocolloids share the “shear thinning” behavior in which non-Newtonian fluids exhibit a decrease in viscosity under shear strain. As a consequence of increasing the shear strain (i.e., shear stress and shear rate), the polymer molecules chains become oriented, aligning themselves generally parallel to the direction of the flow.

The inventors have characterized the rheological behavior of the dispersions, and have investigated the correlation between this rheological behavior and the sweetness taste testing results (or “taste perception”) for sweetener products containing the sweetener formulations.

Moreover, the inventors have observed the rheological behavior of the dispersion at different time intervals of rest (i.e., after carrier addition and mixing) so as to determine the time required for the polymer in the dispersion to swell and settle before transferring the dispersion for drying.

The rheological properties (flow behavior) of each dispersion may be measured by a rheometer before transfering it to the vacuum dryer and after the sugar is ready (in order to study the behavior of the sugar in water and saliva vs. the plain sugar).

As used herein in the specification and in the claims section that follows, the term “glycosidic linkage” refers to covalent bonding between adjacent building blocks or β-glucopyranose monomer units within CMC by means of oxygen (also known as “O-glycosidic” linkage).

The CMC for use in accordance with the formulations and methods of the present invention may have various mucoadhesive properties. For example, the CMC may have numerous hydrophilic groups, such as methoxy groups and hydroxyl groups, which may aid the attachment to mucus or cell membranes through various interactions such as hydrogen bonding and electrostatic interactions.

Mucoadhesion may generally refer to the attachment of particular macromolecules to a mucin layer of a mucosal surface of a human tongue. The mucoadhesive agent's affinity for attaching to a mucin layer of a mucosal surface of a human tongue may be characterized or quantified by various characterization methods.

As used herein in the specification and in the claims section that follows, the terms “mucoadhesion” and “mucosal adhesion” refer to the tendency of a formulation, or of particular macromolecules (e.g., CMC) to attach to a mucin layer of a mucosal surface of a human tongue.

As used herein in the specification and in the claims section that follows, the term “mucoadhesive agent” and the like refers to a substance exhibiting an affinity for attaching to a mucin layer of a mucosal surface of a human tongue, via mucoadhesion.

In some embodiments, the CMC utilized in accordance with the present invention has a specific surface area of at most 150 m²/g, at most 125 m²/g, and more typically, at most 100 m²/g, at most 75 m²/g, at most 50 m²/g, at most 25 m²/g, or at most 10 m²/g.

The sweetener formulation is typically devoid of silicon-containing species such as silica. In some embodiments, the concentration of silicon within the sweetener formulation is at most 1%, at most 0.5%, at most 0.2%, at most 0.1%, at most 0.05%, at most 0.02%, at most 0.01%, at most 0.005%, or at most 0.003%. Typically, the concentration of silicon within the sweetener formulation is at most 0.002%, at most 0.001%, or the sweetener formulation is devoid of silicon.

### EXAMPLES

Reference is now made to the following examples, which together with the above descriptions, illustrate the invention in a non-limiting fashion.

### Equipment

| | | | Measuring | | |
|---|---|---|---|---|---|
| Instruments | Manufacturer | Model | range | Units | Geometry |
| High shear mixer | IKA | IKA T 25 | 3000-25000 | rpm | |
| | | ULTRA- | | | |
| | | TURRAX ® | | | |
| | Silverson | L5M-A | 0-8000 | rpm | |
| Vacuum mixer- | Stephan | UMC 5 | 300-3000 | 1/min | |
| dryer | | | | | |
| (cooking mixer) | | | | | |
| Vacuum pump | Vacuubrand | MZ 2C NT | 50 | Hz | |
| Laboratory oven | MRC Ltd | DFO-150 | 25-250 | ° C. | |
| Ultra centrifugal | Retsch | ZM200 | 50 | Hz | |
| mill | | | | | |
| Pocket | ATAGO | PAL-BX/RI | 0.0-93.0 | % | |
| Refractometer | | | | | |
| Texture analyzer | Stable Micro | TA.XTplus | 0-5000 | g | A/MUC Muco- |
| | Systems | | | | adhesion Test Rig |
| Rheometer | Anton Paar GmbH | MCR 92 | 0-1000 | 1/s | Bob-cup cylinder |
| | | P/N: 159000 | | | |

### Materials

| | | | Viscosity | | Degree of |
|---|---|---|---|---|---|
| Material | Manufacturer | type | (25° C., mPa*s) | | substitution |
| Na-CMC | DOW | Walocel 30 | 25-35 | (2%) | 0.82-0.95 |
| | | Walocel 100 | 110-160 | (2%) | 0.82-0.95 |
| | | Walocel 1000 | 550-800 | (2%) | 0.82-0.95 |
| | | Walocel 10000 | 900-1500 | (1%) | 0.82-0.95 |
| | | Walocel 15000 | 1900-2600 | (1%) | 0.82-0.95 |
| | | Walocel 30000 | 3000-4000 | (1%) | 0.82-0.95 |
| | | Walocel 40000 | 4000-5000 | (1%) | 0.82-0.95 |
| | | Walocel 50000 | 5000-9200 | (1%) | 0.7-0.8 |
| | Blanose | 7LF | 25-50 | (2%) | 0.65-0.90 |
| | | 7MF | 400-600 | (1%) | 0.65-0.90 |
| | | 7HOF | 1000-2800 | (1%) | 0.65-0.90 |
| | | 9H4F | 2500-4500 | (1%) | 0.80-0.90 |

| | | | | |
|---|---|---|---|---|
| | CPKelco | 700 | 500-900 | 0.75-0.85 |
| | | 2000 | 1500-2500 | 0.75-0.85 |
| | | 10000 | 1000-1500 | 0.75-0.85 |
| | | 30000 | 2500-3500 | 0.75-0.85 |
| | | 50000 | 4500-7500 | 0.8-0.9 |
| Ca-CMC | Maple biotech pvt. | E.G.C. 505 | | 0.5-0.7 |
| | ltd | | | |
| | Gotoku chemical | | | 0.5-0.7 |
| | company LTD. | | | |
| | CHINEWAY | | | |
| | INTERNATIONAL | | | |
| Inulin | Beneo | Orafti Highly | | |
| | | Soluble Inulin | | |
| | Cosucra | Fibruline | | |
| | Sensus | Frutafit CLR | | |

### Example 1

### Production of a CMC-Sweetener Dispersion

The CMC and carbohydrate sweetener powders are mixed or blended. The resulting powder mixture is added gradually to water. The requisite amount of CMC is calculated in ratio to the carbohydrate sweetener (weight-weight). For example: in order to prepare about 1 kilogram (typically 65° Bx) of syrup containing 0.1% CMC with respect to the carbohydrate sweetener, 0.65 grams of the CMC are mixed with 650 grams of the carbohydrate sweetener. This mixture is added gradually (under constant mixing) to 350 grams of water, typically at room temperature. The mixing vessel is stirred using an overhead stirrer, typically at 50-800 RPM for at least 45 minutes, or for at least 7 minutes using a high shear mixer (up to 10,000 RPM for IKA; up to 5,000 RPM for Silverson), until the CMC is fully dispersed.

For CMC that is more difficult to disperse, the water fraction may be pre-heated.

### Example 2

### Production of a CMC-Sweetener Dispersion—Full Dispersion

A concentrated sweetener syrup containing one or more carbohydrate sweeteners and/or one or more polyol (typically sugar alcohol) sweeteners, is prepared prior to the addition of the CMC, from room temperature to as much as 80° ° C. in some cases. The default temperature is 60° C. for sucrose and any other di-saccharides, and 70° C. for other sweetener species. The concentration is about 65 wt % for most of the carbohydrate and polyol sweeteners. Some of the lower solubility sweeteners, may require higher water concentrations and/or temperatures in order to fully dissolve. The CMC is then added incrementally or instantaneously under constant mixing. Once the CMC addition has been completed, the mixing vessel continues to be stirred using an overhead stirrer, typically at 50-800 RPM for at least 45 minutes, or for at least 7 minutes using a high shear mixer (up to 10,000 RPM for IKA; up to 5,000 RPM for Silverson), until the CMC is fully dispersed.

When necessary, the syrup is heated to facilitate the dispersion of the CMC.

### Example 3

### Production of a CMC-Sweetener Dispersion—Full Dispersion

The CMC is first dispersed in water. In some cases, the dispersion may be best performed according to the instructions of the manufacturer (e.g., dispersing incrementally in hot water). Once the CMC is fully dispersed, the sweetener (carbohydrate or polyol) is gradually introduced under constant mixing, from room temperature to as much as 80° ° C. in some cases. The default temperature is 60° ° C. for sucrose and any other di-saccharides, and 70° C. for other sweetener species. Mixing may be effected by means of an overhead stirrer (50-800 RPM for at least 45 minutes) or by means of a high-shear mixer (up to 10,000 RPM for at least 7 minutes when using IKA; up to 5,000 RPM for at least 7 minutes when using the Silverson).

Thus, to prepare about a kilogram of a carbohydrate or polyol sweetener syrup containing about 65% carbohydrate sweetener and 0.1% CMC with respect to the carbohydrate sweetener, 0.65 grams of the CMC are first dispersed in 350 grams water. Subsequently, 650 grams of the carbohydrate sweetener are added gradually to the CMC dispersion to produce the syrup.

### Example 4

### Production of a CMC-Sweetener Dispersion—Partial Dispersion

Partial dispersion of the CMC may be deliberately effected. A concentrated sweetener syrup (carbohydrate or polyol) is prepared prior to the addition of the CMC, as described in Example 2. The CMC is then added in instantaneous or substantially instantaneous fashion, without mixing or with gentle mixing, typically up to about 1 minute, so as to deliberately produce small aggregates. In this manner, a concentrated syrup containing partially dispersed CMC is produced.

In this “partial dispersion” procedure, it may best to deviate from the dispersion instructions of the CMC manufacturer, in order to mitigate the dispersion.

### Example 5

Production of a Dry Powder from the Concentrated Syrup

Concentrated syrup (e.g., produced in any of the above-provided examples) is transferred to the heated double-jacketed vessel of the vacuum dryer (e.g., Stephan). The vessel is heated (typically 60° C.-70° C.), maintained under vacuum (typically 50-300 mbar), and mixed constantly, so as to evaporate the water, eventually producing a fine dry powder.

Optionally, the powder may be transferred to an oven operating at 65° C. for further drying for several hours or overnight.

### Example 6

Production of a Dry Powder from the Concentrated Syrup Concentrated syrup (e.g., produced in any of the above-provided production methods) is subjected to the drying process provided in Example 5, after the concentrated syrup has been allowed to rest, typically for 24 hours.

### Example 7

### Production of a CMC-Sweetener Dispersion—Minimal Dispersion

A concentrated sweetener syrup (carbohydrate or polyol) is prepared, as described in Example 2. The concentrated syrup (carbohydrate sweetener and water) is transferred to the vacuum mixer-dryer vessel and mixed constantly under vacuum (50-300 mbar) and heating (55° C.-70° C.) so as to evaporate water and further concentrate the syrup. When the syrup is further concentrated to ca. 70-80 wt. %, the vacuum is released, and the CMC is added to the concentrated syrup.

The CMC is pre-dispersed in a vial. The liquid “dispersant” is typically water, but ethanol or ethanol/water mixtures may also be employed, as necessary, so that the solids are fully suspended. Typically, the CMC to liquid ratio in the pre-dispersion is within a range of 1:1 to 1:5. Mixing is performed by manual shaking of the vial. The contents of the vial are then introduced to the concentrated syrup. The heating and vacuum are reapplied, and the syrup is mixed with the CMC as water evaporates, until a powder is obtained.

Optionally, the powder may be transferred to an oven operating at 65° C. for further drying for several hours or overnight.

### Example 8A

A dispersion containing 0.1% Blanose 7MF (i.e., with respect to the carbohydrate sweetener) was prepared according to Example 3. 0.65 grams of Blanose 7MF were dispersed in 350 grams water. Subsequently, 650 grams sucrose were added gradually to the Blanose 7MF dispersion to produce a concentrated syrup. The syrup was transferred to the heated double-jacketed vessel of the vacuum dryer which was heated and maintained under vacuum according to Example 5, to produce a fine dry powder.

### Example 8B

A dispersion containing 0.1% Blanose 7MF was prepared according to Example 2.

A concentrated sweetener syrup was prepared by adding 650 grams sucrose to 350 grams water while stirring, at 60° C. 0.65 grams of Blanose 7MF were then added incrementally, under constant mixing. The mixing vessel was stirred using an overhead stirrer, until the CMC was fully dispersed.

### Example 9

A dispersion containing 0.2% Blanose 7MF was prepared according to Example 3. 1.3 grams of Blanose 7MF were dispersed in 350 grams water. Subsequently, 650 grams sucrose were added gradually to the Blanose 7MF dispersion to produce a concentrated syrup. The syrup was transferred to the heated double-jacketed vessel of the vacuum dryer which was heated and maintained under vacuum according to Example 6, to produce a fine dry powder.

### Example 10

A dispersion containing 0.3% Blanose 7MF was prepared according to Example 3. 1.95 grams of Blanose 7MF were dispersed in 350 grams water. Subsequently, 650 grams sucrose were added gradually to the Blanose 7MF dispersion to produce a concentrated syrup. The syrup was transferred to the heated double-jacketed vessel of the vacuum dryer which was heated and maintained under vacuum according to Example 6, to produce a fine dry powder.

### Example 11

A dispersion containing 0.5% Blanose 7MF was prepared according to Example 3. 3.25 grams of Blanose 7MF were dispersed in 350 grams water. Subsequently, 650 grams sucrose were added gradually to the Blanose 7MF dispersion to produce a concentrated syrup. The syrup was transferred to the heated double-jacketed vessel of the vacuum dryer which was heated and maintained under vacuum according to Example 6, to produce a fine dry powder.

### Example 12

A dispersion containing 0.8% Blanose 7MF was prepared according to Example 3. 5.2 grams of Blanose 7MF were dispersed in 350 grams water. Subsequently, 650 grams sucrose were added gradually to the Blanose 7MF dispersion to produce a concentrated syrup. The syrup was transferred to the heated double-jacketed vessel of the vacuum dryer which was heated and maintained under vacuum according to Example 6, to produce a fine dry powder.

### Example 13

A dispersion containing 1.0% Blanose 7MF was prepared according to Example 3. 6.5 grams of Blanose 7MF were dispersed in 350 grams water. Subsequently, 650 grams sucrose were added gradually to the Blanose 7MF dispersion to produce a concentrated syrup. The syrup was transferred to the heated double-jacketed vessel of the vacuum dryer which was heated and maintained under vacuum according to Example 6, to produce a fine dry powder.

### Example 14

A dispersion containing 1.2% Blanose 7MF was prepared according to Example 3. 7.8 grams of Blanose 7MF were dispersed in 350 grams water. Subsequently, 650 grams sucrose were added gradually to the Blanose 7MF dispersion to produce a concentrated syrup. The syrup was transferred to the heated double-jacketed vessel of the vacuum dryer which was heated and maintained under vacuum according to Example 6, to produce a fine dry powder.

### Example 15

A dispersion containing 1.5% Blanose 7MF was prepared according to Example 3. 9.75 grams of Blanose 7MF were dispersed in 350 grams water. Subsequently, 650 grams sucrose were added gradually to the Blanose 7MF dispersion to produce a concentrated syrup. The syrup was transferred to the heated double-jacketed vessel of the vacuum dryer which was heated and maintained under vacuum according to Example 6, to produce a fine dry powder.

### Example 16

A dispersion containing 0.02% Blanose 7MF was prepared according to Example 3. 0.13 grams of Blanose 7MF were dispersed in 350 grams water. Subsequently, 650 grams sucrose were added gradually to the Blanose 7MF dispersion to produce a concentrated syrup. The syrup was transferred to the heated double-jacketed vessel of the vacuum dryer which was heated and maintained under vacuum according to Example 6, to produce a fine dry powder.

### Example 17

A dispersion containing 0.05% Blanose 7MF was prepared according to Example 3. 0.325 grams of Blanose 7MF were dispersed in 350 grams water. Subsequently, 650 grams sucrose were added gradually to the Blanose 7MF dispersion to produce a concentrated syrup. The syrup was transferred to the heated double-jacketed vessel of the vacuum dryer which was heated and maintained under vacuum according to Example 6, to produce a fine dry powder.

### Examples 18-27

The formulations of Examples 8 to 17 were prepared, but using fructose instead of sucrose.

### Example 28

A dispersion containing 0.1% Blanose 7HOF was prepared according to Example 3. 0.65 grams of Blanose 7HOF were dispersed in 350 grams water. Subsequently, 650 grams sucrose were added gradually to the Blanose 7HOF dispersion to produce a concentrated syrup. The syrup was transferred to the heated double-jacketed vessel of the vacuum dryer which was heated and maintained under vacuum according to Example 6, to produce a fine dry powder.

### Example 29

A dispersion containing 0.2% Blanose 7HOF was prepared according to Example 3. 1.3 grams of Blanose 7HOF were dispersed in 350 grams water. Subsequently, 650 grams sucrose were added gradually to the Blanose 7HOF dispersion to produce a concentrated syrup. The syrup was transferred to the heated double-jacketed vessel of the vacuum dryer which was heated and maintained under vacuum according to Example 6, to produce a fine dry powder.

### Example 30A

A dispersion containing 0.3% Blanose 7HOF was prepared according to Example 3. 1.95 grams of Blanose 7HOF were dispersed in 350 grams water. Subsequently, 650 grams sucrose were added gradually to the Blanose 7HOF dispersion to produce a concentrated syrup. The syrup was transferred to the heated double-jacketed vessel of the vacuum dryer which was heated and maintained under vacuum according to Example 6, to produce a fine dry powder.

### Example 30B

A dispersion containing 0.3% Blanose 7HOF was prepared according to Example 2. A concentrated sweetener syrup was prepared by adding 650 grams sucrose to 350 grams water while stirring, at 60° C. 1.95 grams of Blanose 7HOF were then added incrementally, under constant mixing. The mixing vessel was stirred using an overhead stirrer, until the CMC was fully dispersed.

### Example 31

A dispersion containing 0.5% Blanose 7HOF was prepared according to Example 3. 3.25 grams of Blanose 7HOF were dispersed in 350 grams water. Subsequently, 650 grams sucrose were added gradually to the Blanose 7HOF dispersion to produce a concentrated syrup. The syrup was transferred to the heated double-jacketed vessel of the vacuum dryer which was heated and maintained under vacuum according to Example 6, to produce a fine dry powder.

### Example 32

A dispersion containing 0.8% Blanose 7HOF was prepared according to Example 3. 5.2 grams of Blanose 7HOF were dispersed in 350 grams water. Subsequently, 650 grams sucrose were added gradually to the Blanose 7HOF dispersion to produce a concentrated syrup. The syrup was transferred to the heated double-jacketed vessel of the vacuum dryer which was heated and maintained under vacuum according to Example 6, to produce a fine dry powder.

### Example 33

A dispersion containing 1.0% Blanose 7HOF was prepared according to Example 3. 6.5 grams of Blanose 7HOF were dispersed in 350 grams water. Subsequently, 650 grams sucrose were added gradually to the Blanose 7HOF dispersion to produce a concentrated syrup. The syrup was transferred to the heated double-jacketed vessel of the vacuum dryer which was heated and maintained under vacuum according to Example 6, to produce a fine dry powder.

### Example 34

A dispersion containing 1.2% Blanose 7HOF was prepared according to Example 3. 7.8 grams of Blanose 7HOF were dispersed in 350 grams water. Subsequently, 650 grams sucrose were added gradually to the Blanose 7HOF dispersion to produce a concentrated syrup. The syrup was transferred to the heated double-jacketed vessel of the vacuum dryer which was heated and maintained under vacuum according to Example 6, to produce a fine dry powder.

### Example 35

A dispersion containing 1.5% Blanose 7HOF was prepared according to Example 3. 9.75 grams of Blanose 7HOF were dispersed in 350 grams water. Subsequently, 650 grams sucrose were added gradually to the Blanose 7HOF dispersion to produce a concentrated syrup. The syrup was transferred to the heated double-jacketed vessel of the vacuum dryer which was heated and maintained under vacuum according to Example 6, to produce a fine dry powder.

### Example 36

A dispersion containing 0.02% Blanose 7HOF was prepared according to Example 3. 0.13 grams of Blanose 7HOF were dispersed in 350 grams water. Subsequently, 650 grams sucrose were added gradually to the Blanose 7HOF dispersion to produce a concentrated syrup. The syrup was transferred to the heated double-jacketed vessel of the vacuum dryer which was heated and maintained under vacuum according to Example 6, to produce a fine dry powder.

### Example 37

A dispersion containing 0.05% Blanose 7HOF was prepared according to Example 3. 0.325 grams of Blanose 7HOF were dispersed in 350 grams water. Subsequently, 650 grams sucrose were added gradually to the Blanose 7HOF dispersion to produce a concentrated syrup. The syrup was transferred to the heated double-jacketed vessel of the vacuum dryer which was heated and maintained under vacuum according to Example 6, to produce a fine dry powder.

### Examples 38-47

The formulations of Examples 28 to 37 were prepared, but using glucose instead of sucrose, and using 550 grams water (instead of 350 grams) in the initial dispersion.

### Example 48

A dispersion containing 0.1% Blanose 9H4F was prepared according to Example 3. 0.65 grams of Blanose 9H4F were dispersed in 350 grams water. Subsequently, 650 grams sucrose were added gradually to the Blanose 9H4F dispersion to produce a concentrated syrup. The syrup was transferred to the heated double-jacketed vessel of the vacuum dryer which was heated and maintained under vacuum according to Example 6, to produce a fine dry powder.

### Example 49

A dispersion containing 0.2% Blanose 9H4F was prepared according to Example 3. 1.3 grams of Blanose 9H4F were dispersed in 350 grams water. Subsequently, 650 grams sucrose were added gradually to the Blanose 9H4F dispersion to produce a concentrated syrup. The syrup was transferred to the heated double-jacketed vessel of the vacuum dryer which was heated and maintained under vacuum according to Example 6, to produce a fine dry powder.

### Example 50

A dispersion containing 0.3% Blanose 9H4F was prepared according to Example 3. 1.95 grams of Blanose 9H4F were dispersed in 350 grams water. Subsequently, 650 grams sucrose were added gradually to the Blanose 9H4F dispersion to produce a concentrated syrup. The syrup was transferred to the heated double-jacketed vessel of the vacuum dryer which was heated and maintained under vacuum according to Example 6, to produce a fine dry powder.

### Example 51

A dispersion containing 0.5% Blanose 9H4F was prepared according to Example 3. 3.25 grams of Blanose 9H4F were dispersed in 350 grams water. Subsequently, 650 grams sucrose were added gradually to the Blanose 9H4F dispersion to produce a concentrated syrup. The syrup was transferred to the heated double-jacketed vessel of the vacuum dryer which was heated and maintained under vacuum according to Example 6, to produce a fine dry powder.

### Example 52

A dispersion containing 0.8% Blanose 9H4F was prepared according to Example 3. 5.2 grams of Blanose 9H4F were dispersed in 350 grams water. Subsequently, 650 grams sucrose were added gradually to the Blanose 9H4F dispersion to produce a concentrated syrup. The syrup was transferred to the heated double-jacketed vessel of the vacuum dryer which was heated and maintained under vacuum according to Example 6, to produce a fine dry powder.

### Example 53

A dispersion containing 1.0% Blanose 9H4F was prepared according to Example 3. 6.5 grams of Blanose 9H4F were dispersed in 350 grams water. Subsequently, 650 grams sucrose were added gradually to the Blanose 9H4F dispersion to produce a concentrated syrup. The syrup was transferred to the heated double-jacketed vessel of the vacuum dryer which was heated and maintained under vacuum according to Example 6, to produce a fine dry powder.

### Example 54

A dispersion containing 1.2% Blanose 9H4F was prepared according to Example 3. 7.8 grams of Blanose 9H4F were dispersed in 350 grams water. Subsequently, 650 grams sucrose were added gradually to the Blanose 9H4F dispersion to produce a concentrated syrup. The syrup was transferred to the heated double-jacketed vessel of the vacuum dryer which was heated and maintained under vacuum according to Example 6, to produce a fine dry powder.

### Example 55

A dispersion containing 1.5% Blanose 9H4F was prepared according to Example 3. 9.75 grams of Blanose 9H4F were dispersed in 350 grams water. Subsequently, 650 grams sucrose were added gradually to the Blanose 9H4F dispersion to produce a concentrated syrup. The syrup was transferred to the heated double-jacketed vessel of the vacuum dryer which was heated and maintained under vacuum according to Example 6, to produce a fine dry powder.

### Example 56

A dispersion containing 0.02% Blanose 9H4F was prepared according to Example 3. 0.13 grams of Blanose 9H4F were dispersed in 350 grams water. Subsequently, 650 grams sucrose were added gradually to the Blanose 9H4F dispersion to produce a concentrated syrup. The syrup was transferred to the heated double-jacketed vessel of the vacuum dryer which was heated and maintained under vacuum according to Example 6, to produce a fine dry powder.

### Example 57

A dispersion containing 0.05% Blanose 9H4F was prepared according to Example 3. 0.325 grams of Blanose 9H4F were dispersed in 350 grams water. Subsequently, 650 grams sucrose were added gradually to the Blanose 9H4F dispersion to produce a concentrated syrup. The syrup was transferred to the heated double-jacketed vessel of the vacuum dryer which was heated and maintained under vacuum according to Example 6, to produce a fine dry powder.

### Example 58

A dispersion containing 0.2% Walocel 30 was prepared according to Example 3. 1.3 grams of Walocel 30 were dispersed in 350 grams water. Subsequently, 650 grams sucrose were added gradually to the Walocel 30 dispersion to produce a concentrated syrup. The syrup was transferred to the heated double-jacketed vessel of the vacuum dryer which was heated and maintained under vacuum according to Example 5, to produce a fine dry powder.

### Example 59

A dispersion containing 0.2% Walocel 100 was prepared according to Example 3. 1.3 grams of Walocel 100 were dispersed in 350 grams water. Subsequently, 650 grams sucrose were added gradually to the Walocel 100 dispersion to produce a concentrated syrup. The syrup was transferred to the heated double-jacketed vessel of the vacuum dryer which was heated and maintained under vacuum according to Example 6, to produce a fine dry powder.

### Example 60

A dispersion containing 0.2% Walocel 1000 was prepared according to Example 3. 1.3 grams of Walocel 1000 were dispersed in 350 grams water. Subsequently, 650 grams sucrose were added gradually to the Walocel 1000 dispersion to produce a concentrated syrup. The syrup was transferred to the heated double-jacketed vessel of the vacuum dryer which was heated and maintained under vacuum according to Example 6, to produce a fine dry powder.

### Example 61

A dispersion containing 0.02% Walocel 10000 was prepared according to Example 3. 0.13 grams of Walocel 10000 were dispersed in 350 grams water. Subsequently, 650 grams sucrose were added gradually to the Walocel 10000 dispersion to produce a concentrated syrup. The syrup was transferred to the heated double-jacketed vessel of the vacuum dryer which was heated and maintained under vacuum according to Example 6, to produce a fine dry powder.

### Example 62

A dispersion containing 0.05% Walocel 15000 was prepared according to Example 3. 0.325 grams of Walocel 15000 were dispersed in 350 grams water. Subsequently, 650 grams sucrose were added gradually to the Walocel 15000 dispersion to produce a concentrated syrup. The syrup was transferred to the heated double-jacketed vessel of the vacuum dryer which was heated and maintained under vacuum according to Example 6, to produce a fine dry powder.

### Example 63

A dispersion containing 0.1% Walocel 30000 was prepared according to Example 3. 0.65 grams of Walocel 30000 were dispersed in 350 grams water. Subsequently, 650 grams sucrose were added gradually to the Walocel 30000 dispersion to produce a concentrated syrup. The syrup was transferred to the heated double-jacketed vessel of the vacuum dryer which was heated and maintained under vacuum according to Example 6, to produce a fine dry powder.

### Example 64

A dispersion containing 0.2% Walocel 40000 was prepared according to Example 3. 1.3 grams of Walocel 40000 were dispersed in 350 grams water. Subsequently, 650 grams sucrose were added gradually to the Walocel 40000 dispersion to produce a concentrated syrup. The syrup was transferred to the heated double-jacketed vessel of the vacuum dryer which was heated and maintained under vacuum according to Example 6, to produce a fine dry powder.

### Example 65

A dispersion containing 0.2% Walocel 50000 was prepared according to Example 3. 1.3 grams of Walocel 50000 were dispersed in 350 grams water. Subsequently, 650 grams sucrose were added gradually to the Walocel 50000 dispersion to produce a concentrated syrup. The syrup was transferred to the heated double-jacketed vessel of the vacuum dryer which was heated and maintained under vacuum according to Example 6, to produce a fine dry powder.

### Example 66

A dispersion containing 0.02% CPKelco 50000 was prepared according to Example 3. 0.13 grams of CPKelco 50000 were dispersed in 350 grams water. Subsequently, 650 grams sucrose were added gradually to the CPKelco 50000 dispersion to produce a concentrated syrup. The syrup was transferred to the heated double-jacketed vessel of the vacuum dryer which was heated and maintained under vacuum according to Example 6, to produce a fine dry powder.

### Example 67

A dispersion containing 0.05% CPKelco 30000 was prepared according to Example 3. 0.325 grams of CPKelco 30000 were dispersed in 350 grams water. Subsequently, 650 grams sucrose were added gradually to the CPKelco 30000 dispersion to produce a concentrated syrup. The syrup was transferred to the heated double-jacketed vessel of the vacuum dryer which was heated and maintained under vacuum according to Example 6, to produce a fine dry powder.

### Example 68

A dispersion containing 0.1% CPKelco 10000 was prepared according to Example 3. 0.65 grams of CPKelco 10000 were dispersed in 350 grams water. Subsequently, 650 grams sucrose were added gradually to the CPKelco 10000 dispersion to produce a concentrated syrup. The syrup was transferred to the heated double-jacketed vessel of the vacuum dryer which was heated and maintained under vacuum according to Example 6, to produce a fine dry powder.

### Example 69

A dispersion containing 0.2% CPKelco 2000 was prepared according to Example 3. 1.3 grams of CPKelco 2000 were dispersed in 350 grams water. Subsequently, 650 grams sucrose were added gradually to the CPKelco 2000 dispersion to produce a concentrated syrup. The syrup was transferred to the heated double-jacketed vessel of the vacuum dryer which was heated and maintained under vacuum according to Example 6, to produce a fine dry powder.

### Example 70

A dispersion containing 0.3% CPKelco 700 was prepared according to Example 3. 1.95 grams of CPKelco 700 were dispersed in 350 grams water. Subsequently, 650 grams sucrose were added gradually to the CPKelco 700 dispersion to produce a concentrated syrup. The syrup was transferred to the heated double-jacketed vessel of the vacuum dryer which was heated and maintained under vacuum according to Example 6, to produce a fine dry powder.

### Example 71

A dispersion containing 0.05% CPKelco 30000 was prepared according to Example 3. 0.325 grams of CPKelco 30000 were dispersed in 350 grams water. Subsequently, 650 grams maltitol were added gradually to the CPKelco 30000 dispersion to produce a concentrated syrup. The syrup was transferred to the heated double-jacketed vessel of the vacuum dryer which was heated and maintained under vacuum according to Example 6, to produce a fine dry powder.

### Example 72

A dispersion containing 0.1% Blanose 9H4F was prepared according to Example 3. 0.65 grams of Blanose 9H4F were dispersed in 350 grams water. Subsequently, 650 grams sorbitol were added gradually to the Blanose 9H4F dispersion to produce a concentrated syrup. The syrup was transferred to the heated double-jacketed vessel of the vacuum dryer which was heated and maintained under vacuum according to Example 6, to produce a fine dry powder.

### Example 73

A dispersion containing 0.3% Blanose 9H4F was prepared according to Example 3. 1.95 grams of Blanose 9H4F were dispersed in 350 grams water. Subsequently, 650 grams xylitol were added gradually to the Blanose 9H4F dispersion to produce a concentrated syrup. The syrup was transferred to the heated double-jacketed vessel of the vacuum dryer which was heated and maintained under vacuum according to Example 6, to produce a fine dry powder.

### Example 74

A dispersion containing 0.3% Blanose 9H4F was prepared according to Example 3. 1.95 grams of Blanose 9H4F were dispersed in 350 grams water. Subsequently, 650 grams lactitol were added gradually to the Blanose 9H4F dispersion to produce a concentrated syrup. The syrup was transferred to the heated double-jacketed vessel of the vacuum dryer which was heated and maintained under vacuum according to Example 6, to produce a fine dry powder.

### Example 75

A dispersion containing 0.5% Blanose 9H4F was prepared according to Example 3. 3.25 grams of Blanose 9H4F were dispersed in 350 grams water. Subsequently, 650 grams sorbitol were added gradually to the Blanose 9H4F dispersion to produce a concentrated syrup. The syrup was transferred to the heated double-jacketed vessel of the vacuum dryer which was heated and maintained under vacuum according to Example 6, to produce a fine dry powder.

### Example 76

A dispersion containing 0.8% Blanose 9H4F was prepared according to Example 3. 5.2 grams of Blanose 9H4F were dispersed in 350 grams water. Subsequently, 650 grams sorbitol were added gradually to the Blanose 9H4F dispersion to produce a concentrated syrup. The syrup was transferred to the heated double-jacketed vessel of the vacuum dryer which was heated and maintained under vacuum according to Example 6, to produce a fine dry powder.

### Example 77

### Preparation of Petit Beurre Biscuit Samples

Two novel petit beurre biscuit samples having reduced sugar content are prepared, both having 40 wt % less sugar with respect to typical commercially available biscuits. Since the full (non-reduced) sugar petit beurre biscuit batter contains 16.5 wt % sugar, each of the two petit beurre biscuit batters described below is formulated to contain about (100%-40%)·16.5%=9.9 wt % sugar.

The biscuit batters also contain 10.6% palm oil and 59% wheat flour (approximately 40% starch). The biscuit batters also contain about 13% water.

Inulin (about 6.6 wt % of the formulation, on a wet basis) is used as a filler to make up the reduced amount of sugar in both samples (16.5%−9.9%=6.6 wt % inulin). Typically, Orafti Highly Soluble Inulin is utilized.

The second petit beurre batter utilizes a sweetener formulation from various exemplary formulations (described hereinabove) containing a minute amount of CMC (e.g., as a mucoadhesive agent). The baked product is referred to as a “CMC Biscuit”. The first petit beurre batter (baked to produce a “Control Biscuit”) is a comparative sample, devoid of the CMC in the sweetener formulation. Thus, the recipes are substantially identical except for this minute amount of CMC. The preparation process is also identical.

### Example 78

### Preparation of Butter Cookie Samples

Two novel butter cookie samples having reduced sugar (typically sucrose) content are prepared, both having approximately 45 wt % less sugar with respect to typical commercially available butter cookies. Since the full sugar (i.e., non-reduced) butter cookie batter contains 19 wt % sugar, each of the two butter cookie batters described below is formulated to contain about (100%-45%)·19%=10.5 wt % sugar.

Inulin (about 8.5 wt % of the formulation) is used as a filler to make up the reduced amount of sugar in both samples (19%−10.5%=8.5 wt % inulin). Typically, Orafti Highly Soluble Inulin is utilized.

The other ingredients are palm oil (14.5%), wheat flour (49%), corn starch (4.2%), egg (3.7%), with water being the remainder.

The second butter cookie batter utilizes a sweetener formulation from various exemplary formulations (described hereinabove) containing a minute amount of CMC. The baked product thereof is referred to as a “CMC Cookie”. The first butter cookie batter (baked to produce a “Control Cookie”) is a comparative sample, devoid of the CMC in the sweetener formulation. Thus, the recipes are substantially identical except for this minute amount of CMC. The preparation process is also identical.

### Example 79

### Taste Evaluation

The exemplary sweetener formulations (e.g., petit beurre biscuits and butter cookies) may be evaluated by trained sensory panelists using a paired-comparison test. The paired-comparison test is a two-product blind test, and the panelists' task is to choose/indicate the sweeter one of the two products (samples). This method is also known as a directional paired-comparison test, with the “directional” component alerting the subject to a specific type of paired test (Sensory Evaluation Practices, 4th Ed., Stone, Bleibaum, Thomas, eds.).

A Comparative Sweetness Index may be calculated from the paired-comparison test results, compiled from all the panelists. For example, if, among 17 panelists, 10 chose the Inventive Biscuit as being sweeter, while the other 7 panelists chose the comparative biscuit, the Comparative Sweetness Index (CSI) would be calculated as:

$$CSI = ( 10 / 17 ) \cdot 100 = 58.8 = 59 ( rounded )$$

### Example 80

### Tensile Strength/Detachment Force-Texture Analysis

The mucoadhesion properties of sweetener formulations were evaluated by performing detachment tests using the TA.XTplus Texture Analyzer. The effect of various mucoadhesive species of CMC on the adhesiveness of the sweetener formulation was also investigated, at various concentrations.

### Materials and Methods

Before the detachment tests were executed, the following steps were performed: tablet preparation from sugar samples, preparation of artificial saliva buffer solution and trimming of fresh pig tongues to pieces of 30 mm×30 mm with thickness of around 20 mm. The tongue tissues were frozen at −20° C. Before the test, the tongue tissue was heated to 37° C. for 5 minutes. In terms of artificial saliva, the solution was prepared according to the following composition (Table 1):

TABLE 1
Artificial Saliva Composition

| | |
|---|---|
| NaHCO₃ | 2.5 mM |
| KCl | 10 mM |
| NaCl | 7.4 mM |
| CaCl₂ | 1.5 mM |
| NaH₂PO₄ | 5.8 mM |

### Tablet Preparation

Tablets, made from the sweetener samples listed in Table 2 provided hereinbelow, were prepared for detachment test using the Tableting Minipress MII machine. “Dry Mix” samples were ground and mixed with magnesium stearate (as a lubricant) at 2 w/w % in a Tumble Mixer for 2 minutes. The mixture was introduced to the Minipress and pressed at an upper punch penetration of 11 mm, to produce flat tablets. The sweetener samples, produced according to Example 3 and dried according to Example 5 or Example 6, were pressed at a lower upper punch penetration of 7.5-9 mm. For all samples, the preparation rate was around 40 tablets/minute, in automatic mode. The diameter of the tablet is 10 mm.

### Detachment Tests

The trimmed pig tongue piece was pressure-fixed between a plastic platform and a lid, by means of four screws. A hole (13 mm in diameter), disposed in the middle of the lid, enables tablet-tongue contact. The plastic platform and pig tongue arrangement was maintained in the artificial saliva solution under constant temperature of 37° C. A sweetener tablet was attached to the Texture Analyzer (TA) probe (cylinder) by means of a double-sided adhesive tape. The measurement was performed using the following procedure: the probe, together with the tablet, was lowered at constant speed until a pre-determined applied force was exerted, for a fixed contact time, with the tongue tissue. Once finished, the probe and tablet were lifted, and the (maximum) detachment force (Fmax) and detachment work (area between the curve and X-axis, also termed “total work of adhesion”) were recorded for each of the sweetener tablets. The whole process was controlled by the TA adhesion test rig, utilizing the settings provided in Table 2.

TABLE 2
Measurement conditions for the detachment tests

| | | |
|---|---|---|
| Pre-test speed | 0.5 | mm/s |
| Test speed | 0.5 | mm/s |
| Post-test speed | 0.1 | mm/s |
| Applied force | 200 | gr |
| Return distance | 5.0 | mm |
| Contact time | 40 | sec |
| Trigger force | 5.0 | gr |
| Saliva buffer amount | 100 | μL |

As used herein, the above-described detachment test procedure is referred to as a “standard detachment test”.

Tablets of various sweetener samples were evaluated to determine the maximum detachment force and the work of detachment, using the equipment and procedures disclosed in Example 80.

In some embodiments, the mucosal adhesion of the sweetener formulation, as characterized by the maximum detachment force, is greater than that of the control composition, (i.e., a formulation being devoid of the CMC, but being otherwise identical to the sweetener formulation in both composition and preparation method). Typically, the mucosal adhesion of the sweetener formulation, as characterized by the maximum detachment force (or by the maximum force of detachment determination (F_{D-D}), defined hereinbelow), is greater than that of the control composition by at least 1%, at least 1.5%, at least 2%, at least 3%, or at least 4%, and in some cases, at least 5%, at least 7%, at least 10%, at least 12%, or at least 15%.

The inventors have further discovered that at relatively high levels of mucosal adhesion (e.g., as characterized by at least one of the maximum detachment force and the work of detachment), the presence of the CMC may actually be detrimental to the sweetness of the food or formulation, as perceived by taste-testing.

Thus, in some embodiments, the mucosal adhesion of the sweetener formulation, as characterized by the maximum detachment force (or by F_{D-D}), is greater than that of the control composition by at most 200%, at most 150%, at most 100%, at most 80%, and more typically, at most 60%, at most 50%, at most 40%, at most 35%, or at most 30%.

In some embodiments, the mucosal adhesion of the sweetener formulation, as characterized by the maximum detachment force (or by F_{D-D}), is greater than that of the control composition by a value within a range of 1% to 200%, 1% to 120%, 1% to 80%, 1% to 60%, 1% to 40%, 1% to 30%, 1% to 25%, 1% to 20%, 1.5% to 60%, 1.5% to 40%, 1.5% to 30%, 1.5% to 25%, 1.5% to 20%, 2% to 200%, 2% to 120%, 2% to 80%, 2% to 60%, 2% to 50%, 2% to 40%, 2% to 30%, 2% to 25%, 2% to 20%, 3% to 80%, 3% to 60%, 3% to 40%, 3% to 30%, 3% to 25%, 3% to 20%, 4% to 60%, 4% to 40%, 4% to 30%, 4% to 25%, 4% to 20%, 5% to 60%, 5% to 40%, 5% to 30%, 5% to 25%, 5% to 20%, 6% to 60%, 6% to 40%, 6% to 30%, 6% to 25%, 6% to 20%, 8% to 50%, 8% to 30%, 8% to 25%, 8% to 20%, 10% to 50%, 10% to 30%, 10% to 25%, or 10% to 20%.

In some embodiments, the mucosal adhesion of the sweetener formulation, as characterized by the work of detachment (or by the detachment work (W_{D}), defined hereinbelow), is greater than that of the control composition, (i.e., as above, a formulation being devoid of the CMC, but being otherwise identical to the sweetener formulation in both composition and preparation method). Typically, the mucosal adhesion of the sweetener formulation, as characterized by the work of detachment, is greater than that of the control composition by at least 1%, at least 1.5%, at least 2%, at least 3%, at least 5%, at least 7%, at least 10%, at least 20%, at least 30%, at least 40%, or at least 45%.

In some embodiments, the mucosal adhesion of the sweetener formulation, as characterized by the work of detachment (or by W_{D}), is greater than that of the control composition by at most 200%, at most 150%, at most 125%, at most 110%, at most 100%, at most 90%, at most 80%, at most 70%, at most 60%, or at most 50%.

In some embodiments, the mucosal adhesion of the sweetener formulation, as characterized by the work of detachment (or by W_{D}), is greater than that of the control composition by a value within a range of 10% to 150%, 10% to 125%, 10% to 100%, 10% to 80%, 20% to 150%, 20% to 125%, 20% to 100%, 20% to 80%, 30% to 150%, 30% to 125%, 30% to 100%, 30% to 80%, 40% to 150%, 40% to 125%, 40% to 100%, 40% to 80%, 50% to 150%, 50% to 125%, 50% to 100%, or 50% to 90%.

As used herein in the specification and in the claims section that follows, the term “maximum detachment force” (F_{Dmax}) refers to the maximum detachment force as measured by the standard detachment test.

As used herein in the specification and in the claims section that follows, the term “detachment work” (W_{D}) refers to the work of detachment as measured by the standard detachment test.

As used herein in the specification and in the claims section that follows, the term “work of detachment determination” (W_{D-D}) for a sweetener formulation containing a particular species of CMC within the sweetener particles thereof, refers to the work of detachment for the identical CMC-containing sweetener formulation, but having a concentration of 1% of that particular species of CMC with respect to the sweetener, and prepared and measured according to the standard procedure of Example 80, the obtained detachment work (W_{D}) then being linearly applied using a coefficient K_{conc} based on the actual concentration (C_{actual}), in %, of that particular CMC disposed within the sweetener particles of the formulation. Similarly, as used herein in the specification and in the claims section that follows, the term “maximum force of detachment determination” (F_{D-D}) for a sweetener formulation containing a particular species of CMC within the sweetener particles thereof, refers to the maximum detachment force (F_{Dmax}) for the identical CMC-containing sweetener formulation, but having a concentration of 1% of that particular species of CMC with respect to the sweetener, and prepared and measured according to the standard procedure of Example 80, the obtained maximum detachment force (F_{Dmax}) then being linearly applied using a coefficient K_{conc} based on the actual concentration (C_{actual}), in %, of that particular species of CMC disposed within the sweetener particles of the formulation. Thus:

$${K}_{conc} = {C}_{actual} / 1 \% \qquad ( A )$$

$${F}_{D - D} = {K}_{conc} \cdot {F}_{D max} \qquad ( B )$$

$${W}_{D - D} = {K}_{conc} \cdot {W}_{D} \qquad ( C )$$

As used herein in the specification and in the claims section that follows, the term “mucosal adhesion” and the like, with respect to a formulation, is meant to refer to mucosal adhesion as exhibited by at least one of maximum detachment force (F_{Dmax}), maximum force of detachment determination (F_{D-D}), detachment work (W_{D}), and work of detachment determination (W_{D-D}).

### Example 81

### Rheological Characterization of Mucoadhesivity

The mucoadhesive properties of various species of CMC were characterized using rheological measurements. It is known that the rheological behavior of the mixture containing the mucoadhesive CMC and mucin may be appreciably influenced by chemical interactions, conformational changes and chain interlocking between the two species. Rheological techniques are used to study the deformation of material and their flow behavior under shear. Such measurement allows monitoring the interactions between polymers (Hassan and Gallo, 1990). Interactions between the mucoadhesive CMC macromolecules and the mucin are manifested by viscosity enhancement, such that the viscosity of the mixture exceeds the sum of the individual viscosities of the mucin and the CMC. Thus, by measuring the individual viscosities, along with the viscosity of the mucin—CMC mixture, the mucoadhesive force between the mucin and the CMC may be characterized, according to the following equation:

$$η t = η m + η p + η b$$

where ηt is the total (measured) viscosity of the system (mixture), ηb is the viscosity component of bioadhesion (viscosity enhancement), nm and np are the individually-measured viscosities of mucin and CMC single-component dispersions, respectively.

Various CMC dispersions of 2 wt % in distilled water were prepared according to the manufacturer instructions and were gently mixed for 3 hours. Dried mucin was hydrated with distilled water (sufficient to make a 10 wt % dispersion) by gentle stirring for 1 hour at room temperature followed by sonication of 10 minutes (at room temperature). The mucin solution was then gently stirred for 2 hours to yield the 10 wt % mucin dispersion. Equal amounts of each CMC dispersion and the 10 wt % mucin dispersion were mixed to yield a final concentration of 1 wt % CMC and 5 wt % mucin for each mixed dispersion. All mixture systems were maintained at 37° ° C. for 1 hour to equilibrate prior to analysis.

All measurements were performed using the Anton Paar MRC92 rheometer having a Peltier temperature chamber: C-PTD 180/air, rotating bob (CC27 concentric cylinder) and a fixed cup (C-CC27/SS/AIR) having a diameter of 28.992 mm. Prior to the measurement, each sample formulation was allowed to rest for another 2 minutes. The measurements were performed at 37° ° C. at a shear rate ranging between 0.1-350 s⁻¹ (logarithmic ramp).

Measurements for each CMC (1 wt %) dispersion and for a 5 wt % mucin dispersion were performed in order to yield the individual viscosities (np, nm). The enhanced viscosity (bioadhesion) was then calculated for each CMC-mucin, according to the above-provided equation.

The mucoadhesive properties of various samples of were characterized using the rheological equipment and methodology provided in Example 81.

It was found that a particular species of CMC can be considered to be mucoadhesive, or to be a mucoadhesive agent, if the bioadhesion viscosity component (ηb), as measured according to the standard procedure of Example 81, at a CMC concentration of 1%, is at least 3 mPa·s. More typically, ηb is at least 5 mPa·s, at least 7 mPa·s, or at least 10 mPa·s. As used herein in the specification and in the claims section that follows, this determination of mucoadhesivity (i.e., whether the CMC is considered to be mucoadhesive, or to be a mucoadhesive agent) is referred to as a “standard rheological determination”.

Typically, this bioadhesion viscosity component (ηb) is within a range of 2-400 mPa·s, 2.5-400 mPa·s, 2-350 mPa·s, 2.5-350 mPa·s, 3-400 mPa·s, 3-350 mPa·s, 3-300 mPa·s, 3-250 mPa·s, 3-200 mPa·s, 3-150 mPa·s, 4-400 mPa·s, 4-350 mPa·s, 4-300 mPa·s, 4-250 mPa·s, 5-400 mPa·s, 5-350 mPa·s, 5-300 mPa·s, 5-250 mPa·s, 5-200 mPa·s, 5-150 mPa·s, 6-400 mPa·s, 6-350 mPa·s, 6-300 mPa·s, 6-200 mPa·s, 6-150 mPa·s, 7-200 mPa·s, 7-150 mPa·s, 8-200 mPa·s, 8-150 mPa·s, 10-200 mPa·s, 10-150 mPa·s, 10-100 mPa·s, 12-200 mPa·s, 12-150 mPa·s, 15-200 mPa·s, 15-150 mPa·s, 20-200 mPa·s, 20-150 mPa·s, or 20-100 mPa·s.

As used herein in the specification and in the claims section that follows, the term “bioadhesive concentration of CMC” and the like refers to a particular concentration of at least one species of CMC disposed within the sweetener particles of a formulation, the particular concentration of the at least one species of CMC being sufficient to attain a value of at least 3 mPa·s for a bioadhesion viscosity component (ηb), as measured according to the standard procedure of Example 81, but at that particular concentration.

As used herein in the specification and in the claims section that follows, the term “bioadhesive content of CMC” and the like, with respect to a CMC-containing formulation, refers to an actual concentration (C_{actual}) of at least one species of CMC disposed within the sweetener particles of the formulation, said actual concentration being sufficient to attain a bioadhesion viscosity increase (Δη_{PS}) of at least 1.0 mPa·s, wherein the bioadhesion viscosity component (ηb) is measured according to the standard procedure of Example 81 at a concentration of 1% CMC, and then linearly applied to obtain Δη_{PS} using a coefficient K_{conc} based on the actual concentration (C_{actual}), in %, of the at least one species of CMC disposed within the sweetener particles of the formulation:

$${K}_{c o n c} = {C}_{actual} / 1 \% \qquad ( I )$$

$$bioadhesion viscosity increase ( Δ {η}_{PS} ) = {K}_{conc} \cdot η b \qquad ( II )$$

Thus, when the bioadhesion viscosity increase (Δη_{PS}) is at least 1.0 mPa·s for C_{actual}, the formulation is deemed to have a bioadhesive content of CMC.

As used herein in the specification and in the claims section that follows, the terms “bioadhesive formulation”, “bioadhesive sweet formulation” and the like refer to a formulation containing at least one of a bioadhesive concentration of CMC and a bioadhesive content of CMC.

### Additional Embodiments

Additional Embodiments 1 to 233 are provided hereinbelow.

Embodiment 1. A sweetener formulation comprising:
(a) sweetener particles containing a sweetener selected from the group consisting of a sweetener carbohydrate and a sweetener polyol; and
(b) a carboxymethyl cellulose (CMC) disposed within said sweetener particles;
wherein a weight-to-weight ratio of said CMC to said sweetener within said sweetener particles is within a range of 0.02% to 1.5%.
   Embodiment 2. A sweetener formulation comprising:
(a) sweetener particles containing a sweetener selected from the group consisting of a sweetener carbohydrate and a sweetener polyol; and
(b) CMC, disposed within said sweetener particles;
wherein a weight content of said CMC within the sweetener formulation, on a dry basis, is within a range of 0.005% to 1.5%.
   Embodiment 3. A sweetener formulation comprising:
(a) sweetener particles containing a sweetener selected from the group consisting of a sweetener carbohydrate and a sweetener polyol; and
(b) CMC, disposed within said sweetener particles;
wherein an average particle size, by weight, of said sweetener particles within the sweetener formulation is at least 50 μm.
   Embodiment 4. A sweetener formulation comprising:
(a) sweetener particles containing a sweetener selected from the group consisting of a sweetener carbohydrate and a sweetener polyol; and
(b) CMC, disposed within said sweetener particles;
wherein an average molecular weight (AMW₅₀) of said CMC disposed within said sweetener particles, in Daltons, is within a range of 10,000 to 1,200,000.
   Embodiment 5. A sweetener formulation comprising:
(a) sweetener particles containing a sweetener selected from the group consisting of a sweetener carbohydrate and a sweetener polyol; and
(b) CMC, disposed within said sweetener particles;
wherein an average degree of polymerization (DP) of said CMC disposed within said sweetener particles is within a range of 50 to 5,000.
   Embodiment 6. A sweetener formulation comprising:
(a) sweetener particles containing a sweetener selected from the group consisting of a sweetener carbohydrate and a sweetener polyol; and
(b) CMC, disposed within said sweetener particles;
wherein said CMC is a mucoadhesive agent.
   Embodiment 7. A sweetener formulation comprising:
(a) sweetener particles containing a sweetener selected from the group consisting of a sweetener carbohydrate and a sweetener polyol; and
(b) CMC, disposed within said sweetener particles;
wherein a mucosal adhesion of the sweetener formulation is greater than that of a control formulation, said control formulation being devoid of said CMC, but being otherwise identical to the sweetener formulation.
   Embodiment 8. A sweetener formulation comprising:
(a) sweetener particles containing a sweetener selected from the group consisting of a sweetener carbohydrate and a sweetener polyol; and
(b) CMC, disposed within said sweetener particles;
wherein a mucosal adhesion of the sweetener formulation is greater than that of a control formulation by at least 1%, and optionally, at least 2%, at least 3%, at least 5%, at least 7%, at least 10%, at least 15%, at least 20%, at least 30%, or at least 50%, said control formulation being devoid of said CMC, but being otherwise identical to the sweetener formulation.
   Embodiment 9. A sweetener formulation comprising:
(a) sweetener particles containing a sweetener selected from the group consisting of a sweetener carbohydrate and a sweetener polyol; and
(b) a carboxymethyl cellulose (CMC), at least a portion of said CMC disposed within said sweetener particles;
wherein a weight ratio of a total amount of said CMC in the sweetener formulation to said portion of said CMC disposed within said sweetener particles is at most 3, and optionally, at most 2, at most 1.5, at most 1.2, or at most 1.1.
   Embodiment 10. A sweetener formulation comprising:
(a) sweetener particles containing a sweetener selected from the group consisting of a sweetener carbohydrate and a sweetener polyol; and
(b) CMC, disposed within said sweetener particles;
wherein a weight-to-weight ratio of said CMC to said sweetener within said sweetener particles is within a range of 0.02% to 1.5%;
and wherein, at a concentration of 100 grams of the sweetener formulation in 900 grams of deionized water, the sweetener formulation exhibits a pH within a range of 4.5 to 11 at 25° C.
   Embodiment 11. The sweetener formulation of any one of the preceding Embodiments, wherein said CMC is represented by the following molecular formula:

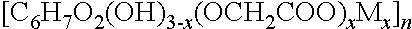

wherein n is the number of repeating units (degree of polymerization);
wherein M is a moiety selected from the group of moieties consisting of an alkali metal, hydrogen (H), or ½ of an alkaline earth metal;
and wherein the degree of substitution is represented by X.
   Embodiment 12. The sweetener formulation of Embodiment 11, wherein said moiety M is an alkali metal.
   Embodiment 13. The sweetener formulation of Embodiment 12, wherein said alkali metal is, or includes sodium.
   Embodiment 14. The sweetener formulation of Embodiment 12, wherein said alkali metal is, or includes potassium.
   Embodiment 15. The sweetener formulation of Embodiment 11, wherein said moiety M is an alkaline earth metal.
   Embodiment 16. The sweetener formulation of Embodiment 15, wherein said alkaline earth metal is, or includes calcium.
   Embodiment 17. The sweetener formulation of Embodiment 16, wherein said alkaline earth metal is, or includes magnesium.
   Embodiment 18. The sweetener formulation of Embodiment 11, wherein said moiety M is, or includes, hydrogen.
   Embodiment 19. A sweetener formulation comprising:
(a) sweetener particles containing a sweetener including a sweetener carbohydrate, and optionally, a sweetener polyol; and
(b) CMC, disposed within said sweetener particles;
wherein a total weight content of said sweetener within the sweetener formulation, is at least 10%;
and wherein an average molecular weight of said CMC disposed within said sweetener particles, in Daltons, is within a range of 10,000 to 1,200,000.
   Embodiment 20. A sweetener formulation comprising:
(a) sweetener particles containing a sweetener including a sweetener polyol, and optionally, a sweetener carbohydrate; and
(b) CMC, disposed within said sweetener particles;
wherein a total weight content of said sweetener within the sweetener formulation, is at least 10%;
and wherein an average molecular weight of said CMC disposed within said sweetener particles, in Daltons, is within a range of 10,000 to 1,200,000.
   Embodiment 21. A sweetener formulation comprising:
(a) sweetener particles containing a sweetener including a sweetener carbohydrate, and optionally, a sweetener polyol; and
(b) CMC, disposed within said sweetener particles;
wherein a weight-to-weight ratio of said CMC to said sweetener within said sweetener particles is within a range of 0.02% to 1.5%.
   Embodiment 22. A sweetener formulation comprising:
(a) sweetener particles containing a sweetener including a sweetener polyol, and optionally, a sweetener carbohydrate; and
(b) CMC, disposed within said sweetener particles;
wherein a weight-to-weight ratio of said CMC to said sweetener within said sweetener particles is within a range of 0.02% to 1.5%.
   Embodiment 23. A sweetener formulation comprising:
(a) sweetener particles containing a sweetener including a sweetener carbohydrate, and optionally, a sweetener polyol; and
(b) CMC, disposed within said sweetener particles;
wherein a weight-to-weight ratio of said CMC to said sweetener within said sweetener particles is within a range of 0.02% to 1.5%;
and wherein said CMC is a mucoadhesive agent.
   Embodiment 24. A sweetener formulation comprising:
(a) sweetener particles containing a sweetener including a sweetener polyol, and optionally, a sweetener carbohydrate; and
(b) CMC, disposed within said sweetener particles;
wherein a weight-to-weight ratio of said CMC to said sweetener within said sweetener particles is within a range of 0.02% to 1.5%;
and wherein said CMC is a mucoadhesive agent.
   Embodiment 25. A sweetener formulation comprising:
(a) sweetener particles containing a sweetener carbohydrate and optionally containing a sweetener polyol; and
(b) CMC, disposed within said sweetener particles;
wherein a weight-to-weight ratio of said CMC to said sweetener within said sweetener particles is within a range of 0.02% to 1.5%;
wherein a total weight content of said sweetener polyol, and said sweetener carbohydrate, within the sweetener formulation, is at least 10%;
wherein an average particle size, by weight, of said sweetener particles within the sweetener formulation is at least 50 μm;
and wherein said CMC is a mucoadhesive agent.
   Embodiment 26. A sweetener formulation comprising:
(a) sweetener particles containing a sweetener selected from the group consisting of a sweetener carbohydrate and a sweetener polyol; and
(b) CMC, disposed within said sweetener particles;
wherein a weight-to-weight ratio of said CMC to said sweetener within said sweetener particles is within a range of 0.02% to 1.5%;
wherein said CMC is represented by the following molecular formula:

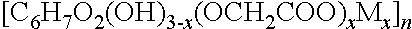

wherein n is the number of repeating units;
wherein M is a moiety selected from the group of moieties consisting of an alkali metal, hydrogen (H), or ½ of an alkaline earth metal;
wherein the degree of substitution is represented by X;
and wherein X is within a range of 0.5 to 1.3.
   Embodiment 27. The sweetener formulation of Embodiment 26, wherein X is within a range of 0.6 to 1.2.
   Embodiment 28. The sweetener formulation of Embodiment 26, wherein X is within a range of 0.6 to 1.0.
   Embodiment 29. The sweetener formulation of Embodiment 26, wherein X is within a range of 0.6 to 0.9.
   Embodiment 30. The sweetener formulation of Embodiment 26, wherein X is within a range of 0.6 to 1.2, and wherein said alkali metal is, or includes, sodium.
   Embodiment 31. The sweetener formulation of Embodiment 26, wherein X is within a range of 0.6 to 1.2, and wherein said alkali metal is, or includes, potassium.
   Embodiment 32. The sweetener formulation of Embodiment 26, wherein X is within a range of 0.6 to 1.2, and wherein said alkaline earth metal is, or includes, calcium.
   Embodiment 33. The sweetener formulation of Embodiment 26, wherein X is within a range of 0.6 to 1.2, and wherein said alkaline earth metal is, or includes, magnesium.
   Embodiment 34. The sweetener formulation of Embodiment 26, wherein X is within a range of 0.6 to 1.2, and wherein said moiety is, or includes, hydrogen.
   Embodiment 35. The sweetener formulation of Embodiment 34, wherein the sweetener formulation exhibits a basic pH at 25° C., for a concentration of 100 grams of the sweetener formulation in 900 grams deionized water.
   Embodiment 36. The sweetener formulation of Embodiment 35, wherein said pH at 25° C. is within a range of 7 to 11.
   Embodiment 37. The sweetener formulation of Embodiment 35, wherein said pH at 25° C. is within a range of 7.5 to 11.
   Embodiment 38. The sweetener formulation of Embodiment 35, wherein said pH at 25° C. is within a range of 8 to 11.
   Embodiment 39. The sweetener formulation of Embodiment 35, wherein said pH at 25° C. is within a range of 8.5 to 11.
   Embodiment 40. The sweetener formulation of any one of the preceding Embodiments, wherein a total weight content of said sweetener polyol, and said sweetener carbohydrate, within the sweetener formulation, is at least 10%.
   Embodiment 41. The sweetener formulation of any one of the preceding Embodiments, wherein said CMC is a mucoadhesive agent.
   Embodiment 42. A sweetener formulation comprising:
(a) sweetener particles containing a sweetener polyol, and optionally, a sweetener carbohydrate; and
(b) CMC, disposed within said sweetener particles;
wherein a weight-to-weight ratio of said CMC to said sweetener within said sweetener particles is within a range of 0.02% to 1.5%;
wherein said CMC is represented by the following molecular formula:

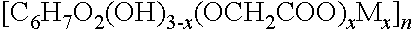

wherein n is the number of repeating units;
wherein M is a moiety selected from the group of moieties consisting of an alkali metal, hydrogen (H), or ½ of an alkaline earth metal;
wherein the degree of substitution is represented by X;
and wherein X is within a range of 0.5 to 1.3.
   Embodiment 43. A sweetener formulation comprising:
(a) sweetener particles containing a sweetener polyol, and optionally, a sweetener carbohydrate; and
(b) CMC, disposed within said sweetener particles;
wherein a weight-to-weight ratio of said CMC to said sweetener within said sweetener particles is within a range of 0.02% to 1.5%;
wherein said CMC is represented by the following molecular formula:

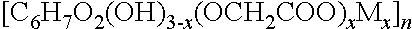

wherein n is the number of repeating units;
wherein M is a moiety selected from the group of moieties consisting of an alkali metal, hydrogen (H), or ½ of an alkaline earth metal;
wherein the degree of substitution is represented by X;
and wherein a solubility of said CMC in water at 25° C. is at least 0.02% by weight of said CMC per weight solution.
   Embodiment 44. The sweetener formulation of Embodiment 43, wherein said solubility of said CMC in water at 25° C. is at least 0.04% by weight of said CMC per weight solution.
   Embodiment 45. The sweetener formulation of Embodiment 43, wherein said solubility of said CMC in water at 25° C. is at least 0.06% by weight of said CMC per weight solution.
   Embodiment 46. The sweetener formulation of Embodiment 43, wherein said solubility of said CMC in water at 25° C. is at least 0.08% by weight of said CMC per weight solution.
   Embodiment 47. The sweetener formulation of Embodiment 43, wherein said solubility of said CMC in water at 25° C. is at least 0.10% by weight of said CMC per weight solution.
   Embodiment 48. The sweetener formulation of Embodiment 43, wherein said solubility of said CMC in water at 25° C. is at least 0.12% by weight of said CMC per weight solution.
   Embodiment 49. The sweetener formulation of Embodiment 43, wherein said solubility of said CMC in water at 25° ° C. is at least 0.15% by weight of said CMC per weight solution.
   Embodiment 50. The sweetener formulation of Embodiment 43, wherein said solubility of said CMC in water at 25° C. is within a range of 0.02% to 0.6% by weight of said CMC per weight solution.
   Embodiment 51. The sweetener formulation of Embodiment 43, wherein said solubility of said CMC in water at 25° C. is within a range of 0.04% to 0.5% by weight of said CMC per weight solution.
   Embodiment 52. The sweetener formulation of Embodiment 43, wherein said solubility of said CMC in water at 25° C. is within a range of 0.06% to 0.4% by weight of said CMC per weight solution.
   Embodiment 53. The sweetener formulation of Embodiment 43, wherein said solubility of said CMC in water at 25° C. is within a range of 0.06% to 0.35% by weight of said CMC per weight solution.
   Embodiment 54. The sweetener formulation of Embodiment 43, wherein said solubility of said CMC in water at 25° C. is within a range of 0.08% to 0.30% by weight of said CMC per weight solution.
   Embodiment 55. The sweetener formulation of Embodiment 43, wherein said solubility of said CMC in water at 25° C. is within a range of 0.15% to 0.35% by weight of said CMC per weight solution.
   Embodiment 56. A sweetener formulation comprising:
(a) sweetener particles containing a sweetener polyol, and optionally containing a sweetener carbohydrate; and
(b) CMC, disposed within said sweetener particles;
wherein a weight-to-weight ratio of said CMC to said sweetener within said sweetener particles is within a range of 0.02% to 1.5%;
wherein a total weight content of said sweetener polyol, and said sweetener carbohydrate, within the sweetener formulation, is at least 20%;
wherein an average particle size, by weight, of said sweetener particles within the sweetener formulation is at least 50 μm;
and wherein said CMC is a mucoadhesive agent.
   Embodiment 57. The sweetener formulation of any one of the preceding Embodiments, wherein said CMC is represented by the following molecular formula:

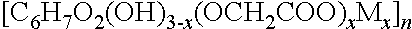

wherein n is the number of repeating units;
wherein M is a moiety selected from the group of moieties consisting of an alkali metal, hydrogen (H), or ½ of an alkaline earth metal;
wherein the degree of substitution is represented by X;
and wherein X is within a range of 0.5 to 1.3.
   Embodiment 58. The sweetener formulation of any one of the preceding Embodiments, wherein a total weight content of said sweetener polyol, and said sweetener carbohydrate, within the sweetener formulation, is at least 25%.
   Embodiment 59. The sweetener formulation of any one of the preceding Embodiments, wherein a total weight content of said sweetener polyol, and said sweetener carbohydrate, within the sweetener formulation, is at least 35%.
   Embodiment 60. The sweetener formulation of any one of the preceding Embodiments, wherein a total weight content of said sweetener polyol, and said sweetener carbohydrate, within the sweetener formulation, is at least 45%.
   Embodiment 61. The sweetener formulation of any one of the preceding Embodiments, wherein a total weight content of said sweetener polyol, and said sweetener carbohydrate, within the sweetener formulation, is at least 60%.
   Embodiment 62. The sweetener formulation of any one of the preceding Embodiments, wherein a total weight content of said sweetener polyol, and said sweetener carbohydrate, within the sweetener formulation, is at least 80%.
   Embodiment 63. The sweetener formulation of any one of the preceding Embodiments, wherein a total weight content of said sweetener polyol, and said sweetener carbohydrate, within the sweetener formulation, is at least 95%.
   Embodiment 64. The sweetener formulation of any one of the preceding Embodiments, wherein a weight-to-weight ratio of said CMC to said sweetener within said sweetener particles is within a range of 0.03% to 1.5%.
   Embodiment 65. The sweetener formulation of any one of the preceding Embodiments, wherein a weight content of said CMC within the sweetener formulation, on a dry basis, is within a range of 0.005% to 1.5%.
   Embodiment 66. The sweetener formulation of any one of the preceding Embodiments, wherein an average particle size, by weight, of said sweetener particles within the sweetener formulation is at least 80 μm.
   Embodiment 67. The sweetener formulation of any one of the preceding Embodiments, wherein an average molecular weight (AMW₅₀) of said CMC disposed within said sweetener particles, in Daltons, is within a range of 10,000 to 1,000,000.
   Embodiment 68. The sweetener formulation of any one of the preceding Embodiments, wherein an or said average degree of polymerization (DP) of said CMC disposed within said sweetener particles, in Daltons, is within a range of 100 to 6,000.
   Embodiment 69. The sweetener formulation of any one of the preceding Embodiments, wherein said CMC is a mucoadhesive agent.
   Embodiment 70. The sweetener formulation of any one of the preceding Embodiments, wherein a or said mucosal adhesion of the sweetener formulation is greater than that of a control formulation, said control formulation being devoid of said CMC, but being otherwise identical to the sweetener formulation.
   Embodiment 71. The sweetener formulation of any one of the preceding Embodiments, wherein a or said mucosal adhesion of the sweetener formulation is greater than that of a control formulation by a value of at least 10%, and optionally, at least 20%, at least 30%, at least 40%, at least 50%, at least 75%, or at least 100%, said control formulation being devoid of said CMC, but being otherwise identical to the sweetener formulation.
   Embodiment 72. The sweetener formulation of any one of the preceding Embodiments, wherein a or said mucosal adhesion of the sweetener formulation is greater than that of a control formulation by a value of 5% to 200%, said control formulation being devoid of said CMC, but being otherwise identical to the sweetener formulation.
   Embodiment 73. The sweetener formulation of Embodiment 72, wherein said mucosal adhesion of the sweetener formulation is greater than that of said control formulation by a value of 10% to 90%.
   Embodiment 74. The sweetener formulation of Embodiment 72, wherein said mucosal adhesion of the sweetener formulation is greater than that of said control formulation by a value of 15% to 90%.
   Embodiment 75. The sweetener formulation of Embodiment 72, wherein said mucosal adhesion of the sweetener formulation is greater than that of said control formulation by a value of 10% to 70%.
   Embodiment 76. The sweetener formulation of any one of the preceding Embodiments, wherein said a value of said mucosal adhesion of the sweetener formulation is determined by a maximum force of detachment determination (F_{D-D}).
   Embodiment 77. The sweetener formulation of any one of the preceding Embodiments, wherein a or said mucosal adhesion of the sweetener formulation is determined by a work of detachment determination.
   Embodiment 78. The sweetener formulation of any one of the preceding Embodiments, wherein a weight ratio of a total amount of CMC in the sweetener formulation to the amount of said CMC distributed within said sweetener particles is at most 8.
   Embodiment 79. The sweetener formulation of any one of the preceding Embodiments, wherein said CMC distributed within said sweetener particles is a first particular CMC, and wherein a weight ratio of a total amount of said first particular CMC in the sweetener formulation to the amount of said first particular CMC distributed within said sweetener particles is at most 4.
   Embodiment 80. The sweetener formulation of any one of the preceding Embodiments, wherein an average particle size, by weight, of said sweetener particles within the sweetener formulation is at least 140 μm.
   Embodiment 81. The sweetener formulation of any one of the preceding Embodiments, wherein said CMC distributed within said sweetener particles is a first particular CMC, and wherein a weight ratio of a total amount of said first particular CMC in the sweetener formulation to the amount of said first particular CMC distributed within said sweetener particles is at most 2.5.
   Embodiment 82. The sweetener formulation of Embodiment 81, wherein said weight ratio of said total amount of said first particular CMC in the sweetener formulation to the amount of said first particular CMC distributed within said sweetener particles is at most 1.5, at most 1.0, or at most 0.5.
   Embodiment 83. The sweetener formulation of any one of the preceding Embodiments, wherein a total weight content of said sweetener particles within the sweetener formulation is at least 25%, and optionally, at least 30%, at least 40%, or at least 50%.
   Embodiment 84. The sweetener formulation of any one of the preceding Embodiments, wherein a total weight content of said sweetener particles within the sweetener formulation is within a range of 10% to 80%.
   Embodiment 85. The sweetener formulation of Embodiment 84, wherein said total weight content of said sweetener particles within the sweetener formulation is within a range of 15% to 70%.
   Embodiment 86. The sweetener formulation of any one of the preceding Embodiments, wherein a total weight content of said sweetener within the sweetener formulation is at least 25%, and optionally, at least 30%, at least 40%, or at least 50%.
   Embodiment 87. The sweetener formulation of any one of the preceding Embodiments, wherein a total weight content of said sweetener within the sweetener formulation is within a range of 10% to 80%.
   Embodiment 88. The sweetener formulation of Embodiment 87, wherein said total weight content of said sweetener within the sweetener formulation is within a range of 15% to 70%.
   Embodiment 89. The sweetener formulation of Embodiment 87, wherein said total weight content of said sweetener within the sweetener formulation is within a range of 25% to 70%.
   Embodiment 90. The sweetener formulation of any one of the preceding Embodiments, wherein a weight content of said sweetener within the sweetener formulation is at least 30%.
   Embodiment 91. The sweetener formulation of any one of the preceding Embodiments, wherein a weight content of said sweetener within the sweetener formulation is at least 40%.
   Embodiment 92. The sweetener formulation of any one of the preceding Embodiments, wherein a weight content of said sweetener within the sweetener formulation is at least 50%.
   Embodiment 93. The sweetener formulation of any one of the preceding Embodiments, wherein a weight content of said sweetener within the sweetener formulation is at least 65%.
   Embodiment 94. The sweetener formulation of any one of the preceding Embodiments, wherein a weight content of said sweetener within the sweetener formulation is at least 75%.
   Embodiment 95. The sweetener formulation of any one of the preceding Embodiments, wherein a weight content of said sweetener within the sweetener formulation is at least 85%.
   Embodiment 96. The sweetener formulation of any one of the preceding Embodiments, wherein a weight content of said sweetener within the sweetener formulation is at least 90%.
   Embodiment 97. The sweetener formulation of any one of the preceding Embodiments, wherein a weight content of said sweetener within the sweetener formulation is at least 95%.
   Embodiment 98. The sweetener formulation of any one of the preceding Embodiments, wherein said sweetener particles have an average particle size (DV50) of at least 30 μm.
   Embodiment 99. The sweetener formulation of any one of the preceding Embodiments, wherein said sweetener particles have an average particle size (DV50) within a range of 30 μm to 1500 μm.
   Embodiment 100. The sweetener formulation of any one of the preceding Embodiments, wherein the sweetener formulation or said sweetener particles have an average particle size (DV50) of at least 50 μm.
   Embodiment 101. The sweetener formulation of any one of the preceding Embodiments, wherein the sweetener formulation or said sweetener particles have an average particle size (DV50) of at least 100 μm.
   Embodiment 102. The sweetener formulation of any one of the preceding Embodiments, wherein the sweetener formulation or said sweetener particles have an average particle size (DV50) of at least 200 μm.
   Embodiment 103. The sweetener formulation of any one of the preceding Embodiments, wherein the sweetener formulation or said sweetener particles have an average particle size (DV50) of at least 350 μm.
   Embodiment 104. The sweetener formulation of any one of the preceding Embodiments, wherein the sweetener formulation or said sweetener particles have an average particle size (DV50) within a range of 100 μm to 1000 μm.
   Embodiment 105. The sweetener formulation of any one of the preceding Embodiments, wherein a or said weight-to-weight ratio of said CMC to said sweetener within said sweetener particles is within a range of 0.03% to 1.5%, 0.03% to 1.2%, 0.03% to 1.0%, 0.03% to 0.8%, 0.03% to 0.7%, 0.03% to 0.6%, 0.03% to 0.5%, 0.05% to 1.75%, 0.05% to 1.5%, 0.05% to 1.4%, 0.05% to 1.3%, 0.05% to 1.2%, 0.05% to 1.0%, 0.05% to 0.7%, 0.1% to 1.75%, 0.1% to 1.5%, 0.1% to 1.4%, 0.1% to 1.3%, 0.1% to 1.2%, 0.1% to 1.0%, 0.1% to 0.8%, 0.1% to 0.7%, 0.1% to 0.6%, 0.15% to 1.75%, 0.15% to 1.5%, 0.15% to 1.4%, 0.15% to 1.3%, 0.15% to 1.2%, 0.15% to 1.0%, 0.15% to 0.8%, 0.2% to 1.75%, 0.2% to 1.5%, 0.2% to 1.4%, 0.2% to 1.3%, 0.2% to 1.2%, 0.2% to 1.0%, 0.2% to 0.8%, 0.2% to 0.7%, 0.2% to 0.6%, 0.25% to 1.75%, 0.25% to 1.5%, 0.25% to 1.4%, 0.25% to 1.3%, 0.25% to 1.2%, 0.25% to 1.0%, 0.25% to 0.8%, 0.25% to 0.7%, or 0.25% to 0.6%.
   Embodiment 106. The sweetener formulation of any one of the preceding Embodiments, wherein said weight-to-weight ratio of said CMC to said sweetener within said sweetener particles is within a range of 0.05% to 1.5%.
   Embodiment 107. The sweetener formulation of any one of the preceding Embodiments, wherein said weight-to-weight ratio of said CMC to said sweetener within said sweetener particles is within a range of 0.1% to 1.5%.
   Embodiment 108. The sweetener formulation of any one of the preceding Embodiments, wherein said weight-to-weight ratio of said CMC to said sweetener within said sweetener particles is within a range of 0.1% to 1.25%.
   Embodiment 109. The sweetener formulation of any one of the preceding Embodiments, wherein said weight-to-weight ratio of said CMC to said sweetener within said sweetener particles is within a range of 0.1% to 1.0%.
   Embodiment 110. The sweetener formulation of any one of the preceding Embodiments, wherein said weight-to-weight ratio of said CMC to said sweetener within said sweetener particles is within a range of 0.1% to 0.8%.
   Embodiment 111. The sweetener formulation of any one of the preceding Embodiments, wherein said weight-to-weight ratio of said CMC to said sweetener within said sweetener particles is within a range of 0.1% to 0.7%.
   Embodiment 112. The sweetener formulation of any one of the preceding Embodiments, wherein said weight content of said CMC within the sweetener formulation, on said dry basis, is at least 0.007%, at least 0.01%, at least 0.025%, at least 0.05%, at least 0.075%, at least 0.1%, at least 0.2%, at least 0.3%, at most 1.5%, at most 1.3%, at most 1.2%, at most 1.1%, at most 1.0%, at most 0.9%, at most 0.8%, at most 0.7%, or at most 0.6%, or within a range of 0.005% to 1.5%, 0.005% to 1.35%, 0.005% to 1.2%, 0.01% to 1.2%, 0.01% to 1.1%, 0.01% to 1.0%, 0.01% to 0.9%, 0.025% to 1.2%, 0.025% to 1.1%, 0.025% to 1.0%, 0.025% to 0.9%, 0.05% to 1.2%, 0.05% to 1.1%, 0.05% to 1.0%, 0.05% to 0.9%, 0.1% to 1.2%, 0.1% to 1.1%, 0.1% to 1.0%, 0.1% to 0.9%, 0.1% to 0.8%, or 0.1% to 0.7%.
   Embodiment 113. The sweetener formulation of any one of the preceding Embodiments, wherein said weight content of said CMC within the sweetener formulation, on said dry basis, is within a range of 0.005% to 1%.
   Embodiment 114. The sweetener formulation of any one of the preceding Embodiments, wherein said weight content of said CMC within the sweetener formulation, on said dry basis, is within a range of 0.015% to 0.3%.
   Embodiment 115. The sweetener formulation of any one of the preceding Embodiments, wherein said weight content of said CMC within the sweetener formulation, on said dry basis, is within a range of 0.015% to 0.1%.
   Embodiment 116. The sweetener formulation of any one of the preceding Embodiments, wherein said average particle size, by weight, of said sweetener particles within the sweetener formulation is at least 60 μm, at least 80 μm, at least 100 μm, at least 120 μm, at least 150 μm; at least 200 μm; at least 220 μm; at least 240 μm, or within a range of 60 μm to 1200 μm, 100 μm to 1200 μm, 120 μm to 1200 μm, 160 μm to 1200 μm, 200 μm to 1200 μm, 240 μm to 1200 μm, 120 μm to 1000 μm, 150 μm to 1000 μm, 180 μm to 1000 μm, 200 μm to 1000 μm, 220 μm to 1000 μm, 240 μm to 1000 μm, 120 μm to 800 μm, 150 μm to 800 μm, 180 μm to 800 μm, 200 μm to 800 μm, 250 μm to 800 μm, or 300 μm to 1200 μm.
   Embodiment 117. The sweetener formulation of any one of the preceding Embodiments, wherein said average particle size, by weight, of said sweetener particles within the sweetener formulation is at least 120 μm.
   Embodiment 118. The sweetener formulation of any one of the preceding Embodiments, wherein said average particle size, by weight, of said sweetener particles within the sweetener formulation is within a range of 150 μm to 1200 μm.
   Embodiment 119. The sweetener formulation of any one of the preceding Embodiments, wherein said AMW₅₀, in Daltons, is within a range of 15,000 to 1,200,000.
   Embodiment 120. The sweetener formulation of Embodiment 119, wherein AMW₅₀ is within a range of 25,000 to 1,200,000 Daltons.
   Embodiment 121. The sweetener formulation of Embodiment 119, wherein AMW₅₀ is within a range of 35,000 to 1,200,000 Daltons.
   Embodiment 122. The sweetener formulation of Embodiment 119, wherein AMW₅₀ is within a range of 50,000 to 1,000,000 Daltons.
   Embodiment 123. The sweetener formulation of Embodiment 119, wherein AMW₅₀ is within a range of 75,000 to 1,000,000 Daltons.
   Embodiment 124. The sweetener formulation of any one of Embodiments 1 to 118, wherein said average molecular weight of said CMC disposed within said sweetener particles, in Daltons, is within a range of 15,000 to 400,000.
   Embodiment 125. The sweetener formulation of Embodiment 124, wherein AMW₅₀ is within a range of 40,000 to 300,000 Daltons.
   Embodiment 126. The sweetener formulation of any one of the preceding Embodiments, wherein an or said average degree of polymerization (DP) of said CMC disposed within said sweetener particles is within a range of 150 to 4,000.
   Embodiment 127. The sweetener formulation of Embodiment 126, wherein DP is within a range of 200 to 4,000.
   Embodiment 128. The sweetener formulation of Embodiment 126, wherein DP is within a range of 250 to 4,000.
   Embodiment 129. The sweetener formulation of Embodiment 126, wherein DP is within a range of 300 to 4,000.
   Embodiment 130. The sweetener formulation of Embodiment 126, wherein DP is within a range of 400 to 4,000.
   Embodiment 131. The sweetener formulation of Embodiment 126, wherein DP is within a range of 600 to 4,000.
   Embodiment 132. The sweetener formulation of Embodiment 126, wherein DP is within a range of 800 to 4,000.
   Embodiment 133. The sweetener formulation of Embodiment 126, wherein DP is within a range of 1000 to 3,500.
   Embodiment 134. The sweetener formulation of Embodiments 126, wherein DP is within a range of 150 to 2,000.
   Embodiment 135. The sweetener formulation of Embodiments 126, wherein DP is within a range of 250 to 2,000.
   Embodiment 136. The sweetener formulation of any one of the preceding Embodiments, wherein a weight ratio of a total amount of CMC in the sweetener formulation to the amount of said CMC distributed within said sweetener particles is at most 2.0.
   Embodiment 137. The sweetener formulation of any one of the preceding Embodiments, wherein a weight ratio of a total amount of CMC in the sweetener formulation to the amount of said CMC distributed within said sweetener particles is at most 1.25.
   Embodiment 138. The sweetener formulation of any one of the preceding Embodiments, wherein said sweetener carbohydrate is selected from at least one of the group consisting of sucrose, glucose, fructose, maltose, lactose, mannose, allulose, tagatose, xylose, galactose, arabinose, galactofructose.
   Embodiment 139. The sweetener formulation of any one of the preceding Embodiments, wherein said sweetener carbohydrate includes sucrose.
   Embodiment 140. The sweetener formulation of any one of the preceding Embodiments, wherein said sweetener carbohydrate includes glucose.
   Embodiment 141. The sweetener formulation of any one of the preceding Embodiments, wherein said sweetener carbohydrate includes fructose.
   Embodiment 142. The sweetener formulation of any one of the preceding Embodiments, wherein said sweetener polyol is selected from at least one of the group consisting of xylitol, maltitol, erythritol, sorbitol, threitol, arabitol, hydrogenated starch hydrolysates (HSH), isomalt, lactitol, mannitol, and galactitol.
   Embodiment 143. The sweetener formulation of any one of the preceding Embodiments, wherein the sweetener formulation is in the form of a particulate solid such as a free-flowing powder.
   Embodiment 144. The sweetener formulation of Embodiment 143, wherein said particulate solid is a powder.
   Embodiment 145. The sweetener formulation of any one of the preceding Embodiments, wherein a or said mucosal adhesion of the sweetener formulation is greater than that of a control formulation by a first value of at least 5%, said control formulation being devoid of said CMC, but being otherwise identical to the sweetener formulation, said mucosal adhesion of the sweetener formulation and of the control formulation being determined by a work of detachment determination.
   Embodiment 146. The sweetener formulation of Embodiment 145, wherein said first value is at most 200%.
   Embodiment 147. The sweetener formulation of Embodiment 145, wherein said first value is within a range of 5% to 180%.
   Embodiment 148. The sweetener formulation of Embodiment 145, wherein said first value is within a range of 10% to 150%.
   Embodiment 149. The sweetener formulation of Embodiment 145, wherein said first value is within a range of 10% to 125%.
   Embodiment 150. The sweetener formulation of Embodiment 145, wherein said first value is within a range of 15% to 110%.
   Embodiment 151. The sweetener formulation of Embodiment 145, wherein said first value is within a range of 5% to 150%, 5% to 125%, 10% to 100%, 10% to 80%, 15% to 125%, 20% to 180%, 20% to 150%, 20% to 125%, 20% to 100%, 20% to 80%, 30% to 150%, 30% to 125%, 30% to 100%, 30% to 80%, 40% to 150%, 40% to 125%, 40% to 100%, 40% to 80%, 50% to 150%, 50% to 125%, 50% to 100%, or 50% to 90%.
   Embodiment 152. The sweetener formulation of any one of Embodiments 145 to 151, wherein said first value is at most 100%, at most 90%, at most 80%, at most 70%, at most 60%, at most 50%, or at most 40%.
   Embodiment 153. The sweetener formulation of any one of the preceding Embodiments, wherein a or said mucosal adhesion of the sweetener formulation is greater than that of a control formulation by a second value of at least 3%, said control formulation being devoid of said CMC, but being otherwise identical to the sweetener formulation, said mucosal adhesion of the sweetener formulation and of the control formulation being determined by a maximum force of detachment determination (F_{D-D}).
   Embodiment 154. The sweetener formulation of Embodiment 153, wherein said second value is at most 150%.
   Embodiment 155. The sweetener formulation of Embodiment 153, wherein said second value is within a range of 3% to 125%.
   Embodiment 156. The sweetener formulation of Embodiment 153, wherein said second value is within a range of 5% to 125%.
   Embodiment 157. The sweetener formulation of Embodiment 153, wherein said second value is within a range of 5% to 100%.
   Embodiment 158. The sweetener formulation of Embodiment 153, wherein said second value is within a range of 5% to 75%.
   Embodiment 159. The sweetener formulation of Embodiment 153, wherein said second value is within a range of 5% to 50%.
   Embodiment 160. The sweetener formulation of Embodiment 153, wherein said second value is within a range of 5% to 35%.
   Embodiment 161. The sweetener formulation of Embodiment 153, wherein said second value is within a range of 7% to 50%.
   Embodiment 162. The sweetener formulation of Embodiment 153, wherein said second value is within a range of 7% to 25%.
   Embodiment 163. The sweetener formulation of Embodiment 153, wherein said second value is within a range of 10% to 50%.
   Embodiment 164. The sweetener formulation of Embodiment 153, wherein said second value is within a range of 3% to 100%, 5% to 60%, 5% to 40%, 7% to 100%, 7% to 80%, 7% to 70%, 7% to 60%, 7% to 40%, 8% to 60%, 8% to 40%, 8% to 30%, 10% to 80%, 10% to 60%, 10% to 35%, or 10% to 30%.
   Embodiment 165. The sweetener formulation of any one of Embodiments 153 to 164, wherein said second value is at most 65%, at most 60%, at most 55%, at most 50%, at most 45%, at most 40%, at most 35%, at most 30%, at most 25%, or at most 20%.
   Embodiment 166. The sweetener formulation of any one of the preceding Embodiments, wherein a or said mucosal adhesion of the sweetener formulation is greater than that of a control formulation by a first value of at least 5%, said control formulation being devoid of said CMC, but being otherwise identical to the sweetener formulation, said first value being determined by a work of detachment determination; and wherein a or said mucosal adhesion of the sweetener formulation is greater than that of said control formulation by a second value of at least 3%, said second value being determined by a maximum force of detachment determination (F_{D-D}).
   Embodiment 167. The sweetener formulation of Embodiment 153, wherein said first value is within a range of 5% to 150%, and wherein said second value is within a range of 3% to 75%.
   Embodiment 168. The sweetener formulation of Embodiment 153, wherein said first value is within a range of 10% to 125%, and wherein said second value is within a range of 5% to 50%.
   Embodiment 169. The sweetener formulation of any one of the preceding Embodiments, wherein a concentration of silicon within the sweetener formulation is at most 1%, at most 0.5%, or at most 0.3%.
   Embodiment 170. The sweetener formulation of any one of the preceding Embodiments, wherein a or said concentration of silicon within the sweetener formulation is at most 0.2%, at most 0.1%, at most 0.05%, at most 0.02%, at most 0.01%, at most 0.005%, or at most 0.003%.
   Embodiment 171. The formulation of any one of the preceding Embodiments, wherein the mucosal adhesion is greater than that of the control composition by a value within a mucosal adhesion range of 1% to 200%.
   Embodiment 172. The formulation of any one of the preceding Embodiments, wherein the mucosal adhesion range is 1% to 80%.
   Embodiment 173. The formulation of Embodiment 171, wherein the mucosal adhesion range is 1.5% to 60%.
   Embodiment 174. The formulation of Embodiment 171, wherein the mucosal adhesion range is 2% to 50%.
   Embodiment 175. The formulation of Embodiment 171, wherein the mucosal adhesion range is 3% to 40%.
   Embodiment 176. The formulation of Embodiment 171, wherein the mucosal adhesion range is 5% to 30%.
   Embodiment 177. The formulation of Embodiment 171, wherein the mucosal adhesion range is 1% to 90%.
   Embodiment 178. The formulation of Embodiment 171, wherein the mucosal adhesion range is 2% to 90%.
   Embodiment 179. The formulation of Embodiment 171, wherein the mucosal adhesion range is 2% to 70%.
   Embodiment 180. The formulation of Embodiment 171, wherein the mucosal adhesion range is 2% to 60%.
   Embodiment 181. The formulation of Embodiment 171, wherein the mucosal adhesion range is 2% to 45%.
   Embodiment 182. The formulation of Embodiment 171, wherein the mucosal adhesion range is 2.5% to 60%.
   Embodiment 183. The formulation of Embodiment 171, wherein the mucosal adhesion range is 2.5% to 45%.
   Embodiment 184. The formulation of Embodiment 171, wherein the mucosal adhesion range is 3% to 70%.
   Embodiment 185. The formulation of Embodiment 171, wherein the mucosal adhesion range is 3% to 60%.
   Embodiment 186. The formulation of Embodiment 171, wherein the mucosal adhesion range is 3% to 50%.
   Embodiment 187. The formulation of Embodiment 171, wherein the mucosal adhesion range is 4% to 50%.
   Embodiment 188. The formulation of any one of Embodiments 177-187, wherein the mucosal adhesion range is at most 40%.
   Embodiment 189. The formulation of any one of Embodiments 171-188, wherein the mucosal adhesion range is at least 5%.
   Embodiment 190. The formulation of any one of Embodiments 171-188, wherein the mucosal adhesion range is at least 6%.
   Embodiment 191. The formulation of any one of Embodiments 171-188, wherein the mucosal adhesion range is at least 7%.
   Embodiment 192. The formulation of any one of Embodiments 177-191, wherein the mucosal adhesion range is at most 35%.
   Embodiment 193. The formulation of any one of Embodiments 177-191, wherein the mucosal adhesion range is at most 32%.
   Embodiment 194. The formulation of Embodiments 171-193, wherein the value of the mucosal adhesion of the formulation is determined by a maximum detachment force (F_{Dmax}).
   Embodiment 195. The formulation of Embodiments 171-194, wherein the value of the mucosal adhesion of the formulation is determined by a maximum force of detachment determination (F_{D-D}).
   Embodiment 196. The formulation of Embodiments 171-195, wherein the value of the mucosal adhesion of the formulation is determined by a detachment work (W_{D}).
   Embodiment 197. The formulation of Embodiments 171-196, wherein the value of the mucosal adhesion of the formulation is determined by a work of detachment determination (W_{D-D}).
   Embodiment 198. The formulation of any one of the preceding Embodiments, wherein the formulation is a bioadhesive formulation.
   Embodiment 199. The formulation of Embodiment 198, wherein the bioadhesive formulation contains a bioadhesive concentration of CMC.
   Embodiment 200. The formulation of Embodiment 198, wherein the bioadhesive formulation contains a bioadhesive content of CMC.
   Embodiment 201. The formulation of any one of the preceding Embodiments, wherein a or the mucosal adhesion of the formulation is greater than that of a or said control composition by a first value of at least 1.5%, the control composition being devoid of the CMC, but being otherwise identical to the formulation, the mucosal adhesion of the formulation and of the control composition being determined by at least one of a detachment work (W_{D}) and a work of detachment determination (W_{D-D}).
   Embodiment 202. The formulation of Embodiment 201, wherein the mucosal adhesion of the formulation and of the control composition is determined by W_{D}.
   Embodiment 203. The formulation of Embodiment 201, wherein the mucosal adhesion of the formulation and of the control composition is determined by W_{D-D}.
   Embodiment 204. The formulation of any one of Embodiments 201 to 203, wherein the first value is at most 200%.
   Embodiment 205. The formulation of any one of Embodiments 201 to 203, wherein the first value is within a range of 2% to 180%.
   Embodiment 206. The formulation of any one of Embodiments 201 to 203, wherein the first value is within a range of 3% to 150%.
   Embodiment 207. The formulation of any one of Embodiments 201 to 203, wherein the first value is within a range of 4% to 125%.
   Embodiment 208. The formulation of any one of Embodiments 201 to 203, wherein the first value is within a range of 5% to 110%.
   Embodiment 209. The formulation of any one of Embodiments 201 to 203, wherein the first value is within a range of 5% to 150%, 5% to 125%, 10% to 100%, 10% to 80%, 15% to 125%, 20% to 180%, 20% to 150%, 20% to 125%, 20% to 100%, 20% to 80%, 30% to 150%, 30% to 125%, 30% to 100%, or 30% to 80%.
   Embodiment 210. The formulation of any one of Embodiments 201 to 209, wherein the first value is at most 100%, at most 90%, at most 80%, at most 70%, at most 60%, at most 50%, at most 40%, or at most 30%.
   Embodiment 211. The formulation of any one of the preceding Embodiments, wherein a or the mucosal adhesion of the formulation is greater than that of a or said control composition by a second value of at least 3%, the control composition being devoid of the CMC, but being otherwise identical to the formulation, the mucosal adhesion of the formulation and of the control composition being determined by at least one of a maximum detachment force (F_{Dmax}) and a maximum force of detachment determination (F_{D-D}).
   Embodiment 212. The formulation of Embodiment 211, wherein the mucosal adhesion of the formulation and of the control composition is determined by F_{Dmax}.
   Embodiment 213. The formulation of Embodiment 211, wherein the mucosal adhesion of the formulation and of the control composition is determined by F_{D-D}.
   Embodiment 214. The formulation of any one of Embodiments 211 to 213, wherein the second value is at most 150%.
   Embodiment 215. The formulation of any one of Embodiments 211 to 213, wherein the second value is within a range of 1% to 125%.
   Embodiment 216. The formulation of any one of Embodiments 211 to 213, wherein the second value is within a range of 1.5% to 125%.
   Embodiment 217. The formulation of any one of Embodiments 211 to 213, wherein the second value is within a range of 1.5% to 100%.
   Embodiment 218. The formulation of any one of Embodiments 211 to 213, wherein the second value is within a range of 1.5% to 75%.
   Embodiment 219. The formulation of any one of Embodiments 211 to 213, wherein the second value is within a range of 1.5% to 50%.
   Embodiment 220. The formulation of any one of Embodiments 211 to 213, wherein the second value is within a range of 1% to 35%.
   Embodiment 221. The formulation of any one of Embodiments 212 to 214, wherein the second value is within a range of 1% to 50%.
   Embodiment 222. The formulation of any one of Embodiments 211 to 213, wherein the second value is within a range of 2% to 50%.
   Embodiment 223. The formulation of any one of Embodiments 212 to 214, wherein the second value is within a range of 2% to 35%.
   Embodiment 224. The formulation of any one of Embodiments 211 to 213, wherein the second value is within a range of 3% to 100%, 5% to 60%, 5% to 40%, 7% to 100%, 7% to 80%, 7% to 70%, 7% to 60%, 7% to 40%, or 7% to 25%.
   Embodiment 225. The formulation of any one of Embodiments 211 to 224, wherein the second value is at most 65%, at most 60%, at most 55%, at most 50%, at most 45%, at most 40%, at most 35%, at most 30%, at most 25%, or at most 20%.
   Embodiment 226. An edible formulation comprising:
(a) the sweetener formulation of any one of Embodiments 1 to 225;
(b) at least one fat; and
(c) optionally, at least one starch;
wherein a total concentration of said sweetener, said at least one fat, and said at least one starch, within the edible formulation, is at least 30%, on a weight basis.
   Embodiment 227. The edible formulation of Embodiment 226, wherein a weight content of said sweetener within the edible formulation is at least 8%.
   Embodiment 228. The edible formulation of Embodiment 226 or Embodiment 227, containing at least 5% of said sweetener, and at least 5% of said at least one fat.
   Embodiment 229. The edible formulation of any one of Embodiments 226 to 228, containing at least 5% of said sweetener, and at least 5% of said at least one starch.
   Embodiment 230. The edible formulation of any one of Embodiments 226 to 229, wherein a weight concentration of said sweetener particles within the edible formulation is within a range of 10% to 80%.
   Embodiment 231. The edible formulation of any one of the preceding Embodiments, containing at least 5% of the sweetener, at least 5% of a or the at least one fat, and at least 5% of a or the at least one starch.
   Embodiment 232. The edible formulation of any one of the preceding Embodiments, containing at least 2%, at least 5%, or at least 10% of an edible filler.
   Embodiment 233. The edible formulation of any one of the preceding Embodiments, containing at least 10% of the sweetener, at least 10% of a or the at least one fat, and at least 10% of a or the at least one starch.

Average molecular weight may be based on the number of molecules in the population, which is termed “number average molecular weight”, or “AMW_{N}”, or may be based on the weight of the molecules, which is termed “weight average molecular weight”, or “AMW₅₀”. As used herein in the specification and in the claims section that follows, the term “average molecular weight” refers to AMW₅₀, unless otherwise specified.

As opposed to small molecules, which may have a unique molecular weight readily derived from their chemical formula, generally provided in grams/mole, polymers and other macromolecules typically exist as a diverse population of distinct molecules, which are therefore characterized by an average molecular weight often expressed in Daltons.

The molecular weight or average molecular weight of such materials is generally provided by the manufacturer or supplier thereof. In addition, the molecular weight or average molecular weight of such materials may be independently determined by known analytical methods, including, by way of example, gel permeation chromatography, high pressure liquid chromatography (HPLC), or matrix-assisted laser desorption/ionization time-of-flight mass spectroscopy (MALDI-TOF MS).

Average particle size (D50) may be based on the number of particles in the population (“D_{N}50”) or may be based on the volume of particles (D_{V}50). These measurements may be obtained by various known methods including static light scattering (SLS), dynamic light scattering (DLS), sieving, and various methods of microscopy. Some methods may be preferred for larger ranges of particles, others may be preferred for smaller ranges of particles.

As used herein in the specification and in the claims section that follows, the term “pH”, with respect to a sweetener formulation, refers to the measured pH for the sweetener at a concentration of 100 grams sweetener formulation in 900 grams deionized water, at a specified temperature (typically, and by default, at 25° C.).

As used herein in the specification and in the claims section that follows, the term “percent”, or “%”, refers to percent by weight, unless specifically indicated otherwise.

As used herein in the specification and in the claims section that follows, the term “starch” is meant to include edible starches that are used or may be used in foodstuffs. Typically, such starches include at least one of amylose and amylopectin, and more typically, both amylose and amylopectin. It will be appreciated that various modifications of starch may be made, in order to impart to a particular foodstuff, or to the starch therein, specific chemical and/or physical properties, including, by way of example, the prevention of gelling at cold temperatures, withstanding low pH, or resistance to high shear or to high temperatures.

Often, starch is present in an ingredient, e.g., flour. In white wheat flour, the starch content is typically about 68%. In oats, the starch content is typically about 58%.

In addition to including fats that are solid at room temperature (25° C.), e.g., beef fat, shortening, palm oil, and butter, as used herein in the specification and in the claims section that follows, the term “fat” is meant to include edible oils, including those that are liquid at room temperature, e.g., cooking oils. Specific examples of edible oils are olive oil, walnut oil, corn oil, and cottonseed oil.

Fats may be a separate ingredient, or may be an ingredient within a food ingredient. For example, hazelnut paste and cocoa powder both contain fat.

Average particle size (D50) may be based on the number of particles in the population (“D_{N}50”) or may be based on the volume of particles (D_{V}50). These measurements may be obtained by various known methods including static light scattering (SLS), dynamic light scattering (DLS), sieving, and various methods of microscopy. Some methods may be preferred for larger ranges of particles, others may be preferred for smaller ranges of particles.

As used herein in the specification and in the claims section that follows, the term “percent”, or “%”, refers to percent by weight, unless specifically indicated otherwise. However, with specific regard to formulations containing CMC and at least one sweetener, the weight-percent of the CMC is with respect to the sweetener. By way of example, in such a formulation containing 1.95 grams CMC dispersed in a syrup containing 650 grams sucrose and 350 grams water, the weight-percent of CMC is 1.95/650=0.3%.

As used herein in the specification and in the claims section that follows, the term “concentration” refers to concentration on a weight basis, unless specifically indicated otherwise.

The term “ratio”, as used herein in the specification and in the claims section that follows, refers to a weight ratio, unless specifically indicated otherwise.

The modifier “about” and “substantially” used in connection with a quantity is inclusive of the stated value and has the meaning dictated by the context (for example, it includes at least the degree of error associated with the measurement of the particular quantity). When used with a specific value, it should also be considered as disclosing that value.

In the context of the present application and claims, the phrase “at least one of A and B” is equivalent to an inclusive “or”, and includes any one of “only A”, “only B”, or “A and B”. Similarly, the phrase “at least one of A, B, and C” is equivalent to an inclusive “or”, and includes any one of “only A”, “only B”, “only C”, “A and B”, “A and C”, “B and C”, or “A and B and C”.

It will be appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

1. A sweetener formulation comprising:
(a) sweetener particles containing a sweetener selected from the group consisting of a sweetener carbohydrate and a sweetener polyol; and
(b) a carboxymethyl cellulose (CMC) disposed within said sweetener particles;
wherein a weight-to-weight ratio of said CMC to said sweetener within said sweetener particles is within a range of 0.02% to 1.5%;
wherein a total weight content of said sweetener polyol and said sweetener carbohydrate within the sweetener formulation, is at least 10%;
and wherein a mucosal adhesion of the sweetener formulation is greater than that of a control formulation by a value of 1% to 200%, said control formulation being devoid of said CMC, but being otherwise identical to the sweetener formulation.

2. The sweetener formulation of claim 1, wherein said mucosal adhesion is greater than that of said control formulation by at least 2%.

3. The sweetener formulation of claim 1, wherein said mucosal adhesion is greater than that of said control formulation by 3% to 80%.

4. The sweetener formulation of claim 1, wherein said mucosal adhesion is greater than that of said control formulation by 3% to 60%.

5. The sweetener formulation of claim 1, wherein said mucosal adhesion is greater than that of said control formulation by 4% to 30%.

6. The sweetener formulation of claim 1, wherein said mucosal adhesion is determined by at least one of a maximum force of detachment determination (F_{D-D}) and a maximum detachment force (F_{Dmax}).

7. The sweetener formulation of claim 1, wherein said mucosal adhesion is determined by at least one of a work of detachment determination (W_{D-D}) and a detachment work (W_{D}).

8. The sweetener formulation of claim 1, wherein the average particle size (Dv50) of the sweetener formulation or said sweetener particles is within a range of 100 to 1500 micrometers (μm).

9. The sweetener formulation of claim 1, wherein said total weight content is at least 60%.

10. The sweetener formulation of claim 1, wherein said weight-to-weight ratio within a range of 0.1% to 0.8%.

11. The sweetener formulation of claim 1, wherein said sweetener carbohydrate includes sucrose.

12. The sweetener formulation of claim 1, wherein the sweetener formulation is a free-flowing powder.

13. he formulation of claim 1, wherein the formulation is a bioadhesive formulation.

14. (canceled)

15. The formulation of claim 13, wherein the bioadhesive formulation contains a bioadhesive concentration of CMC.

16. The formulation of claim 13, wherein the bioadhesive formulation contains a bioadhesive content of CMC.

17. An edible formulation comprising:
(a) the sweetener formulation of claim 1;
(b) at least one fat; and
(c) optionally, at least one starch;
wherein a total concentration of said sweetener, said at least one fat, and said at least one starch, within the edible formulation, is at least 30%, on a weight basis.

18. The edible formulation of claim 17, wherein a weight content of said sweetener within the edible formulation is at least 8%.

19. The edible formulation of claim 17, containing at least 5% of said sweetener, and at least 5% of said at least one fat.

20. The edible formulation of claim 17, containing at least 5% of said sweetener, and at least 5% of said at least one starch.

21. The edible formulation of claim 20, wherein a weight concentration of said sweetener particles within the edible formulation is within a range of 10% to 80%.
